(19) United States
(12) Patent Application Publication
(10) Pub. No.: US 2006/0157559 A1
(43) Pub. Date: Jul. 20, 2006

(54) Systems and methods for document verification

(76) Inventors: Kenneth L. Levy, Stevenson, WA (US); Leo M. Kenen, Bedford, MA (US); Tony F. Rodriguez, Portland, OR (US); Victor L. Andelin, Kendallville, IN (US)

Correspondence Address: DIGIMARC CORPORATION, 9405 SW GEMINI DRIVE, BEAVERTON, OR, 97008, US

(21) Appl. No.: 11/177,252

(22) Filed: Jul. 7, 2005

Related U.S. Application Data
(60) Provisional application No. 60/586,066, filed on Jul. 7, 2004.

(51) Int. Cl. G06K 5/00

(52) U.S. Cl. 235/380

(57) ABSTRACT

A method for issuing a credential includes scanning in documents (e.g., breeder or ID documents) used to verify the applicant of the credential and creating data records including the image of the documents. As a means to reduce fraud, these data records are linked to the credential and to the issuer location, operator and time and place of issuance. If the document includes machine readable information, the method automatically reads the machine readable information from the document and uses at least part of the machine readable information from the document to pre-populate a form used to create a credential, such as an identification document. The method includes applying a transformation to the image of the document that enables protection against fraudulent use. The transformation secures the image of the document from tampering and/or enables tracking of the use of the document image to deter fraud. A method of verifying a credential comprises reading a physical security feature attribute on the credential, reading a logical attribute on the credential, and comparing information from the physical security feature with the logical storage element on the credential to verify the credential.

### RELATED APPLICATION DATA

This application claims priority to U.S. Provisional Application 60/586,066, filed Jul. 7, 2004 and is related to the following commonly assigned U.S. provisional and nonprovisional patent applications, all of which are incorporated by reference:

All in One Capture Station for Creating Identification Documents, Ser. No. 10/676,362, Attorney Docket No. P0885D, filed Sep. 30, 2003, Publication No. 2005-0068420;

Enhanced Shadow Reduction System and Related Techniques for Digital Image Capture, Ser. No. 10/663,439, Attorney Docket No. P0883D, filed Sep. 15, 2003, Publication No. 2004-0140459;

Covert Variable Information on Identification Documents and Methods of Making Same, Application No. 10/330,032, Attorney Docket No. P0732D, filed Dec. 24, 2002, Publication No. 2003-0173406—Inventors Robert Jones and Daoshen Bi;

Systems and Methods for Managing and Detecting Fraud in Image Databases Used With Identification Documents, Application No. 10/723,240, Attorney Docket No. P0910D, filed Nov. 26, 2003—Inventors James V. Howard and Francis Frazier;

All In One Capture station for Creating Identification Documents, Application No. 10/676,362, Attorney Docket No. P0885D, filed Sep. 30, 2003, Publication No. 2005-0068420;

Systems and Methods for Recognition of Individuals Using Multiple Biometric Searches, Application No. 10/686,005, Attorney Docket No. P0899D, Publication No. 2004-0133582—Inventors James V. Howard and Francis Frazier;

Multifunction All In One Capture Station for Creating Identification Documents, Application No. 60/564,820, filed Apr. 22, 2004;

Uniquely Linking Security Elements in Identification Documents, Ser. No. 60/488,536, Attorney Docket Number P0853D, inventors Robert Durst, Robert Jones, and Leo Kenen, filed Jul. 17, 2003;

Three Dimensional Data Storage, Ser. No. 10/825,852, Attorney Docket Number P0972D, inventors Robert Jones and Leo Kenen, filed Apr. 16, 2004, Publication No. 2005-0040240;

Identification Document and Related Methods, Application No. 10/686,495 filed Oct. 14, 2003, Attorney Docket No. P0895W-Inventors Burt Perry, Trent Brundage, Mahmood Sher-Jan, Brett Hannigan, Robert T. Durst, Jr., Matthew Weaver, Brett Bradley, and John Stach;

Method and System for Recognizing Security Documents (U.S. Pat. No. 6674886, issued Jan. 6, 2004, inventors Bruce L. Davis et al.);

Watermark Embedder and Reader (U.S. Pat. No. 6614914, issued Sep. 2, 2003, inventors Geoffrey B. Rhoads et al.);

Printing and Validation of Self Validating Security Documents (U.S. Pat. No. 6,389,151, issued May 14, 2002, inventors Jonathan Scott Carr et al.);

Security System for Photographic Identification (U.S. Pat. No. 5,841,886, issued Nov. 24, 1998, inventor Geoffrey B. Rhoads); and

Computer System Linked by Using Information in Data Objects (U.S. Pat. No. 6,122,403, issued Sep. 19, 2000, inventor Geoffrey B. Rhoads).

Each of the above U.S. Patent documents is herein incorporated by reference in its entirety

### TECHNICAL FIELD

The present invention generally relates to identification and security documents, and in particular, relates to systems and methods for verifying the authenticity of such documents.

### BACKGROUND AND SUMMARY

Identification Documents Generally

Identification documents (also referred to as “ID documents”) play a critical role in today's society. One example of an ID document is an identification card (“ID card”). ID documents are used on a daily basis—to prove identity, to verify age, to access a secure area, to evidence driving privileges, to cash a check, and so on. Airplane passengers are required to show an ID document during check in, security screening and prior to boarding their flight. In addition, because we live in an ever-evolving cashless society, ID documents are used to make payments, access an automated teller machine (ATM), debit an account, or make a payment, etc.

(For the purposes of this disclosure, ID documents are broadly defined herein, and include, e.g., credit cards, bank cards, phone cards, passports, driver's licenses, network access cards, employee badges, debit cards, security cards, visas, immigration documentation, national ID cards, citizenship cards, social security cards, security badges, certificates, identification cards or documents, voter registration cards, police ID cards, border crossing cards, legal instruments, security clearance badges and cards, gun permits, gift certificates or cards, membership cards or badges, etc., etc. Also, the terms “document,” “card,” “badge” and “documentation” are used interchangeably throughout this patent application.).

Many types of identification cards and documents, such as driving licenses, national or government identification cards, bank cards, credit cards, controlled access cards and smart cards, 20 carry thereon certain items of information which relate to the identity of the bearer. Examples of such information include name, address, birth date, signature and photographic image; the cards or documents may in addition carry other variant data (i.e., data specific to a particular card or document, for example an employee number) and invariant data (i.e., data common to a large number of cards, for example the name of an employer). All of the cards described above will hereinafter be generically referred to as “ID documents”.

As those skilled in the art know, ID documents such as driver's licenses can contain so-called “physical” information, such as photographic image or hologram, as well as so-called “machine readable” information, such as a 1D or 2D bar code or a magnetic stripe. Either or both of the machine readable and physical information can further be embedded with a steganographic code, such as a digital watermark. Either or both of the machine readable and physical information can include so-called “fixed” information (information that is the same from ID document to ID document), variable personal information, such as an address, signature, and/or birthdate, biometric information associated with the person whose image or information appears elsewhere (e.g., a fingerprint), a magnetic stripe (which, for example, can be on the a side of the ID document that is opposite the side with the photographic image), and various security features, such as a security pattern (for example, a printed pattern comprising a tightly printed pattern of finely divided printed and unprinted areas in close proximity to each other, such as a fine-line printed security pattern as is used in the printing of banknote paper, stock certificates, and the like).

An exemplary ID document can comprise a substrate or core layer (which can be pre-printed), such as a light-colored, opaque material (e.g., polycarbonate, TESLIN (available from PPG Industries) polyvinyl chloride (PVC) material, etc). In certain instances and with certain printing or information forming technologies, variable or personalized data can be formed directly on the substrate or core layer. In other instances, the core layer may be coated and/or laminated with another material to enable printing or other methods of forming information. For example, the substrate or core layer can be laminated with a transparent material, such as clear polycarbonate or PVC to form a so-called “card blank”. The transparent laminate can be coated with a receiver layer to facilitate certain types of printing, as described in commonly assigned U.S. Pat. No. 6,066,594, which is hereby incorporated by reference.

Information, such as variable personal information (e.g., photographic information), can formed on the card blank using one or more methods, such as laser xerography, offset printing, Indigo, intaglio, laser engraving or marking, inkjet printing, thermal or mass transfer printing, dye diffusion thermal transfer (“D2T2”) printing, etc. The information can, for example, comprise an indicium or indicia, such as the invariant or non-varying information common to a large number of identification documents, for example the name and logo of the organization issuing the documents. Generally, such information may be formed by any known process capable of forming the indicium on the specific core material used.

Certain technologies for forming or printing information may require further protection of the information, so an additional layer of transparent overlaminate can be coupled to the core layer or card blank and the information printed thereon, as is known by those skilled in the art. Illustrative examples of usable materials for overlaminates include polycarbonate, biaxially oriented polyester, or other optically clear durable plastic film.

In the production of images useful in the field of identification documentation, it may be desirable to embody into a document (such as an ID card, drivers license, passport or the like) data or indicia representative of the document issuer (e.g., an official seal, or the name or mark of a company or educational institution) and data or indicia representative of the document bearer (e.g., a photographic likeness, name or address). Typically, a pattern, logo or other distinctive marking representative of the document issuer will serve as one means of verifying the authenticity, genuineness or valid issuance of the document. A photographic likeness or other data or indicia personal to the bearer will validate the right of access to certain facilities or the prior authorization to engage in commercial transactions and activities.

Identification documents, such as ID cards, having printed background security patterns, designs or logos and identification data personal to the card bearer have been known and are described, for example, in U.S. Pat. No. 3,758,970, issued Sep. 18, 1973 to M. Annenberg; in Great Britain Pat. No. 1,472,581, issued to G. A. O. Gesellschaft Fur Automation Und Organisation mbH, published Mar. 10, 1976; in International Patent Application PCT/GB82/00150, published Nov. 25, 1982 as Publication No. WO 82/04149; in U.S. Pat. No. 4,653,775, issued Mar. 31, 1987 to T. Raphael, et al.; in U.S. Pat. No. 4,738,949, issued Apr. 19, 1988 to G. S. Sethi, et al.; and in U.S. Pat. No. 5,261,987, issued Nov. 16, 1993 to J. W. Luening, et al. All of the aforementioned documents are hereby incorporated by reference.

One response to the problem of counterfeiting ID documents has involved the integration of verification features that are difficult to copy by hand or by machine, or which are manufactured using secure and/or difficult to obtain materials. One such verification feature is the use in the card of a signature of the card's issuer or bearer. Other verification features have involved, for example, the use of watermarks, biometric information, microprinting, covert materials or media (e.g., ultraviolet (UV) inks, infrared (IR) inks, fluorescent materials, phosphorescent materials), optically varying images, fine line details, validation patterns or marking, and polarizing stripes. These verification features are integrated into an identification card in various ways, as appreciated by those skilled in the art, and they may be visible or invisible (covert) in the finished card. If invisible, they can be detected by viewing the feature under conditions which render it visible. At least some of the verification features discussed above have been employed to help prevent and/or discourage counterfeiting.

Covert security features are those features whose presence is not visible to the user without the use of special tools (e.g., UV or IR lights, digital watermark readers) or knowledge. In many instances, a covert security feature is normally invisible to a user. Some technologies that involve invisible features require the use of specialized equipment, such as a detector or a device capable of reading digital watermarks. One type of covert security feature is the printing of information (images, designs, logos, patterns, text, etc.) in a material that is not visible under normal lighting conditions, but can be viewed using a special non-visible light source, such as an ultraviolet (UV) or infrared (IR) light source. Use of UV and/or IR security features can be advantageous because although the devices (for example, UV and/or IR light sources) required to see and use such features are commonly available at a reasonable cost, the ability to manufacture and/or copy at least some implementations of such features is far less common and can be very costly. UV and IR based covert security features thus can help deter counterfeiters because the features cannot be copied by copiers or scanners and are extremely difficult to manufacture without the requisite know-how, equipment, and materials.

Issuance of Identification Documents

FIG. 1 is a high level illustration of an exemplary process 100 for the issuance, manufacture, and authentication of an identification document. An applicant presents herself to an issuer with the intent of obtaining and/or renewing an identification document (step 105). Part of this initial step includes an applicant proving to the issuer who she is, typically by presenting one or more tangible documents (such as identification documents). An employee of the issuer looks at the documents to manually verify them (e.g., seeing if the applicant's face matches a picture, typing in a database to see if the applicant's address on an ID document matches a record on file, etc.). When the applicant has cleared the manual verification (step 105). She can proceed to data capture (step 110), where function such as any one or more of the following may occur:

(a) capturing personalized information (e.g., using cameras for photographic images, scanners, readers, and/or cameras for biometric data, electronic signature pads for signatures, etc):

(b) entering information (e.g., using keyboards and/or pointing devices for entering name and address, etc.); and/or

(c) processing the transaction (e.g., using point of sale (POS) devices, credit card readers, receipt printers, etc).

Systems and processes for capturing applicant information are presumed to be well known to those of skill in the art. Illustrative examples of some of such systems can be found, for example, in the following commonly assigned U.S. patent applications, each of which is hereby incorporated by reference:

All in One Capture Station for Creating Identification Documents, Ser. No. 10/676,362, Attorney Docket No. P0885D, filed Sep. 30, 2003, Publication No. 2005-0068420;

Enhanced Shadow Reduction System and Related Techniques for Digital Image Capture, Ser. No. 10/663,439, Attorney Docket No. P0883D, filed Sep. 15, 2003, Publication No. 2004-0140459;

Systems and Methods for Managing and Detecting Fraud in Image Databases Used With Identification Documents, Application No. 10/723,240, Attorney Docket No. P0910D, filed Nov. 26, 2003-Inventors James V. Howard and Francis Frazier;

All In One Capture station for Creating Identification Documents, Application no. 10/676,362, Attorney Docket No. P0885D, filed Sep. 30, 2003, Publication No. 2005-0068420;

Systems and Methods for Recognition of Individuals Using Multiple Biometric Searches, Application No. 10/686,005, Attorney Docket No. P0899D, Publication No. 2004-0133582—Inventors James V. Howard and Francis Frazier; and

Multifunction All In One Capture Station for Creating Identification Documents, Application No. 60/564,820, filed Apr. 22, 2004;

When data capture is complete, the identification document is produced for the applicant (steps 115 and 12)). Identification document production can include:

(a) producing a permanent or temporary identification document (e.g., using printers to produce temporary paper identification documents, so-called “over the counter” or on the spot identification document printers and/or laminators, and so-called “central issue” and other large scale identification printing systems);

(b) storing the captured information for future retrieval and/or providing to external sources (e.g., memory systems, image storage systems, etc.); and

(c) performing all processing, device control, communications, and other operations (both automated and manual) necessary to perform functions (a) through (e=d), e.g. via a computer, such as a standalone computer system.

Processes for manufacturing identification (step 115) documents in various environments, such as so-called central issue (CI) card production systems and so-called “over the counter” (also known as “on the spot”) card production systems are well known to those of skill in the art. Illustrative examples of such processes are described, for example, in the following commonly assigned, published U.S. patent applications, each of which is hereby incorporated by reference:

Identification Card Printed With Jet Inks and Systems and Methods of Making Same, Application No. 10/289,962, Attorney Docket No. P0708D, Inventors Robert Jones, Dennis Mailloux, and Daoshen Bi, filed Nov. 6, 2002, Publication No. 2003-0211296;

Multiple Image Security Features for Identification Documents and Methods of Making Same, Application No. 10/325,434, Attorney Docket No. P728D, filed Dec. 18, 2002, now U.S. Pat. No. 6,817,530 Inventors Brian Labrec, Joseph Anderson, Robert Jones, and Danielle Batey;

Covert Variable Information on Identification Documents and Methods of Making Same, Application No. 10/330,032, Attorney Docket No. P0732D, filed Dec. 24, 2002, Publication No. 2003-0173406—Inventors: Robert Jones and Daoshen Bi;

Identification Card Printer-Assembler for Over the Counter Card Issuing (Application No. not yet assigned, Attorney Docket No. P0829D, filed May 12, 2003—Inventors Dennis Mailloux, Robert Jones, and Daoshen Bi);

Verification of Identification Documents

Despite the many security features and other technologies that have been developed for use with or on identification documents, many types of fraud can still occur. In particular, alteration of identification documents and/or counterfeiting of identification documents (and other documents of value) can be a problem even if an identification document is designed to include security features such as ultraviolet indicia, two dimensional bar codes, retro-reflective overlaminates, computer chips (e.g., smart card chips), holograms, etc., etc. This can occur simply because merely adding these features to an identification document does not guarantee that the features will serve their purpose—some entity still needs to actually check the identification document for these and other features. This lack of checking can also occur with so-called breeder documents, which are the documents a person might use or present as part of being issued an identification document (e.g., by showing one form of ID to obtain another, such as showing a driver's license and/or birth certificate to show proof one's identity when obtaining a passport).

Various companies have attempted to create devices for reading some portion of an identification document to check that portion for one or more features. For example, Imaging Automation of Bedford, N.H. has developed a product line called I-AUTHENTICATE, which it describes as hardware/software platform to authenticate documents automatically. Intelli-Check, Inc. of Woodbury NY offers a product called ID CHECK that it describes as hardware and software solution that can determine the validity of an identification document. AssureTec Systems, of Manchester, N.H. offers an I-DENTIFY reader-authenticator that can capture full color, infrared (IR), ultraviolet (UV) and coaxial images from various identification documents, and an ASSUREID software engine that can classify, read, extract data from, and authenticate documents. ID Logix (part of Concord EFS of Memphis, Tenn.) offers a hand held terminal an associated service that is described as able to authenticate document formats found in magnetic strips and/or 2D barcodes. Positive Access of Eden Prairie, Minn. also offers software that can read and decode digital information stored in magnetic stripes and 2D bar codes.

Each of the above products from the various suppliers is intended to verify only specific aspects of identification documents at only very specific levels. There are no presently available solutions that can link together the various different authentication solutions as part of a cohesive process for thoroughly checking all aspects of an identification document. There are no presently available systems that can leverage the beneficial synergistic effect of using multiple document authentication systems to check a document not only against referenced data in databases but against all other features stored and/or present on the document.

In addition, none of the presently available systems listed above, even if used together, are able to capture, analyze and/or authenticate substantially all of the possible features on an identification document. For example, identification documents such as drivers licenses that are issued by a number of states now include images that have a steganographic code embedded therein, or a digitally watermarked image, but none of the above-described systems include any capability for reading, analyzing, and/or authenticating such an image. As those skilled in the art know, digital watermarking is a process for modifying physical or electronic media to embed a machine-readable code into the media. The media may be modified such that the embedded code is imperceptible or nearly imperceptible to the user, yet may be detected through an automated detection process. In some embodiments, the identification document includes two or more digital watermarks. Several particular digital watermarking techniques have been developed. The reader is presumed to be familiar with the literature in this field. Some techniques for embedding and detecting imperceptible watermarks in media signals are detailed in the patents documents previously listed and incorporated by reference.

Credential and other Authentication/Verification Solutions

We have developed systems, methods, and components that can overcome at least some of the aforementioned limitations.

In one embodiment of the invention, we provide a solution that can permit a document issuer to ascertain the authenticity of identification documents provided by customers. One embodiment of this system, which the assignee of this invention will soon make commercially available under the trade name CENTRIAN PROOF, is a unique document authentication system. CENTRIAN PROOF (which is merely a trade name and is not, of course, intended to be limiting) can flag cases where potentially fraudulent documents are being used by an applicant, thus reducing the likelihood of issuing valuable identity documents to people attempting to use a false identity during the issuing process.

One embodiment of the invention provides a document authentication system (also referred to herein as Credential Verification System or CVS) that can be readily integrated into the workflow of an identification document issuer, such as a department of motor vehicles (DMV). In one embodiment, an issuer workflow includes a CVS component that performs comprehensive check on the physical and machine readable features of many types of travel and breeder documents, including out-of-state DL/ID cards, passports and US-issued visas, etc. The CVS checks each of the “breeder” documents presented by an applicant for both physical and logical authenticity and supplies the operator with feedback concerning the authenticity of the document.

In one advantageous embodiment, we provide a truly unique system for document verification by combining “best-of-breed” hardware and software into a seamless, easy-to-use product. At least some embodiments of the CVS give an issuer the ability to verify many common types of breeder documents at multiple levels. For example, in one embodiment, we provide an imaging device (such as a high resolution imager) that is coupled to a computer (e.g., a personal computer) via an IEEE 1394 (i.e., Firewire) connection and a serial connection and which includes advanced logic to automate the inspection of documents and allow examination of presented credentials. The credentials could include documents having physical document attributes, machine readable (also referred to as “logical”) document attributes, digital watermark (DWM) attributes, biometric attributes, and/or source information attributes. The imaging device provides a high quality image of the document that can be used for further analysis to check various attributes on the document. The document can be imaged one side at a time or both sides at a time, depending on the imager used. The document can be imaged such that one side is imaged and processed (e.g., attributes checked and analyzed) before the other side is imaged and processed.

In at least some embodiments of the invention, we check for all possible attributes on a document. In at least some embodiments of the invention, we check (and cross-check) at least physical document attributes, machine readable document attributes, and DWM attributes.

Physical Document Attributes (also referred to as physical characteristics) In at least some embodiments of the invention, we consider physical document attributes to be indicia or other features of identification documents that could, for example, also be “human readable” features, even if the feature itself contains machine readable information—an example of this would be a driver's license portrait (which is visible to a human and would be the “physical feature”) that happens to also contain an embedded digital watermark (invisible to a human, which would be a machine readable feature. Physical Document Attributes can also includes features that are readable to a human only under certain conditions, such as by viewing through a reader, when under illumination by a light having a certain wavelength (e.g., UV), etc. Physical document attributes include (but are not limited to) the features listed in Table 1.

TABLE 1
Physical Attributes
Security Features

| | |
|---|---|
| Optically Variable | A device, such as a hologram, Kinegram, feature printed using one or more optically varying inks, etc., that |
| Device (OVD) | looks different based on the angle/light at which it is viewed. Some OVD's can also convey sensation of depth |
| Invisible/Covert Inks | Inks used to print images or indicia where ink is invisible unless subjected to specific condition, such as light at |
| | a certain wavelength (e.g., UV, IR), a predetermined temperature (.e.g., thermachromic inks), etc. |
| Altered (or Modified) | Slight modifications of text characters are obvious only to those who are trained to look for them. |
| Fonts | |
| Retroreflective devices | Devices that have a retroreflective appearance when illuminated with a focused light source. Some types also |
| | have tactile feel |
| Core Inclusion | Core of ID document comprises several different layers of ID stock, which can be detected by viewing edge, |
| | especially if one of the layers has a color different than the others |
| Fine-Line Printing | A pattern of fine lines, similar to those found on currency, can be placed on documents and photo backgrounds. |
| | This feature can thwart attempts at photocopying. |
| Security Thread | A thread visible by viewing in reflected or transmitted light and can have text or other feature is thread; |
| | sometimes seen in U.S. banknotes |
| Ghost Image | Faint photo image covers printed data, making it virtually impossible to alter. Requires no special equipment for |
| | verification. |
| Microprinting | Used on currency, the resolution required to create this printing on the base material is far beyond that of any |
| | known photocopier. Often combined with misspelled words, this feature also prevents misuse of base material. |
| | Can be read with a small (10) power magnifier. |
| Optically Variable | Images or text are printed on a card's inner laminate with gold or silver optically variable ink. This printing |
| Indicia | appears and disappears with the angle of viewing and cannot be photocopied or altered without destroying core |
| | laminate. Inks show a color shift depending on angle of viewing Requires no special equipment for verification. |
| Signature Area | Signature is captured electronically and printed digitally. |
| Split Fountain | Use of a color degrade that can't be color copied. |
| Unique or Sequential | Numbers can be added for authentication and to keep track of production materials. |
| Numbering | |
| Rainbow Printing | A subtle shift of color across a document |
| Card Text and/or OCR | Text (e.g., variable data such as name and address) printed on a card that can be read by human & via OCR |
| (optical character | |
| recognition) | |
| Redundant Data | Data displayed on more than one location n a document; may be in differing colors or fonts |
| Overlapping Images | Overlapping images prevent tampering or image substitution. |
| Multicolor UV | Multicolor images made from red, green and blue ultraviolet ink are visible only when viewed under an |
| | ultraviolet light source. |
| Optical Two-Color | Two-color optical printing causes an image or text to shift from one color to another with the viewing angle. |
| Printing | Feature is destroyed with tampering. Cannot be color copied. |
| Pattern Printing | This feature incorporates both visible and ultraviolet printing of a pattern or logo on the inner surface of the |
| | laminate. Can't be reproduced with photography or copying. |
| Ultraviolet Ink | Images printed in UV ink on the laminate are visible only under and ultraviolet light source. Alteration destroys |
| | feature. Can't be photocopied. |
| Security Indicia | Incorporates words or symbols that are concealed on document and appear only when specially grooved plastic |
| | viewer is moved across it. Provides inexpensive authentication. Prevents fraudulent use of base material. |
| Laser perforation | Perforation of a document using laser technology; can create a feature that is visible only in reflected and/or |
| | transmitted light |
| Tactile features/ | Features such as raised areas that can be felt with a finger; can be created via laser. |
| embossed text | |
| Writeable Back | Specified area allows an ID to accept ball-point pen ink. |
| Microtaggant Particles | Microscopic particles are color-coded by customer, and can only be seen under a microscope. Optional UV |
| | fluorescent feature offers “quick check.” |

In at least one embodiment of the invention, the invention includes hardware, software, systems and/or processes that can analyze physical characteristics of identification documents and compare the physical characteristics to an extensive, continuously updated database of documents to determine authenticity. For example, in at least one embodiment of the invention we might detect that a document is a driver's license from Massachusetts, and a system implementing our invention would check to see if certain physical features, such as a ghost image matching the driver's license portrait, are present on the document, in the proper locations.

As part of the imaging and analysis of physical document attributes, The documents are imaged under multiple lighting conditions and in several wavelengths of light (visible, ultraviolet (UV) and infrared (IR)) to enable systems embodying the invention to detect the presence (or absence) of specific characteristics. In at least some embodiments, advanced pattern and color matching techniques can be used to detect advanced security features and other known characteristics to verify the authenticity of documents. Documents, such as DL/ID cards, can be initially categorized using sophisticated document recognition techniques, eliminating the need for operator selection of document type.

Machine-Readable Attributes: In at least some embodiments of the invention, we consider machine-readable attributes to be information on a document that is, as the name implies, readable by machine. Note that in some instances a machine-readable attribute might also be a physical attribute. At least some embodiments of our invention provide systems and methods that can provide logical authentication of all types of machine-readable document attributes. Examples of machine-readable document attributes can, for example, include 1D and 2D bar codes, text contained in ICAO document Machine Readable Zones (MRZ), and magnetic stripes. Physical document attributes can include (but are not limited to) the features listed in Table 2.

TABLE 1
Machine Readable Attributes
Security Features

| | |
|---|---|
| Optically Variable Device | A device, such as a hologram, Kinegram, feature printed using one or more optically varying inks, etc., that |
| (OVD) | looks different based on the angle/light at which it is viewed. Some OVD's can also convey sensation of |
| | depth. Some OVD's (e.g., Kinegram) can include a machine readable portion. |
| Invisible/Covert Inks | Inks used to print images or indicia where ink is invisible unless subjected to specific condition, such as |
| | light at a certain wavelength (e.g., UV, IR), a predetermined temperature (.e.g., thermachromic inks), etc. |
| 1-D and 2-D Bar Codes | Bar codes allow data to be stored on cards. 1-D conforms to AAMVA standard. 2-D conforms to AAMVA |
| | and PDF47 standards. |
| Card Text and/or OCR | Text (e.g., variable data such as name and address) printed on a card that can be read by human & via |
| (optical character | OCR |
| recognition) | |
| Biometrics | Unique features of the card carrier (fingerprints or iris patterns) are tied to an identifier, often a number, and |
| | recorded in a database. The identifier is encrypted and printed on the issued card. The system scans the |
| | card carrier′s unique identifier and matches it against the information in the database to confirm the card |
| | carrier′s identity. Biometrics are used for both 1-to-1 authentication at the time of renewal/registration and |
| | 1-to-many verification of the new applicant's unique identity as compared to the database of existing |
| | document holders. This reduces the opportunity for obtaining valid identity documents under false |
| | pretenses. As an integrator of secure identification technologies, Digimarc favors no specific biometric |
| | technology and recommends solutions based on the client's technology and political environments. |
| Unique or Sequential | Numbers can be added for authentication and to keep track of production materials. |
| Numbering | |
| Digital Watermarking | Digital watermarking technology allows issuers to embed digital codes in cards. These embedded codes |
| (note this technology also | can be imperceptible to humans, but read by image-capture devices enabled with special reader software. |
| merits its own individual | Unlike overt data carrying features, such as barcodes, there is little to alert the forger that a security feature |
| analyses - see below) | exists. Even if the forger is aware of the feature's existence, it is virtually impossible for the counterfeiter to |
| | manipulate that feature in that document or replicate it in another. The covert digital watermark carries a |
| | packet of digital data used to authenticate the card and enhance cardholder verification. Typically, this |
| | covert signal will carry data, such as a document number, expiration date, birth date, or other data specific |
| | to the bearer. The software-based reader can easily be added to primary or secondary inspection. |
| | Examination of documents that use digital watermarks can reveal alteration or forgery by comparing the |
| | digital watermark data to other card data. |
| Magnetic Stripe | Magnetic stripes can be encoded with information, such as demographic data. Available in standard or high |
| | coercivity. Conforms to AAMVA, ANSI and ISO standards. |

We expressly contemplate that as future machine readable technologies become available, our invention can be adapted to read the information. In one embodiment of the invention, we capture all bar code and MRZ information directly from the high resolution images of the document and require no add-on equipment. In an advantageous embodiment, we perform optical character recognition (OCR), not only on text contained in the MRZ, but also on plain text (e.g., printed document number and birth date) contained on the document face. Magnetic stripe information is read using a reader conveniently attached to the scanning unit.

Generally, all machine readable data is decoded and authenticated using currently available technology. Data contained in a document MRZ can be examined for checksum digit accuracy and is further compared to additional data extracted from the document. Information contained in bar codes and magnetic stripes is compared for content and format accuracy to a constantly updated database of existing US and Canadian DL/ID cards.

Digital Watermark Verification: In at least some embodiments if the invention, systems, software, hardware, and/or methods implementing invention operate on a principle that the key to document authentication is the use of all available data to make a judgment as to document authenticity. As the number of US DL/ID cards containing digital watermarking (such as the assignee's Digimarc's IDMarc Digital Watermark (DWM)) continues to grow, we believe that verification of the presence (or absence) of this feature will become increasingly more important to verifying the authenticity of these documents. For example, at the time of first filing this patent application, the assignee's IDMarc feature is being implemented on ten US driver's license and identification document (DL/ID) systems, with the expectation of a continued high adoption rate. At least some embodiments of the invention describe herein offer perhaps the only automated identification document verification and authentication solution that provides the ability to detect and read digital watermarks such as embedded IDMarc DWMs. In one embodiment, the advanced logic of a system implementing the invention determines whether the subject document should include an embedded DWM and verify its contents. As with the other categories of machine-readable data, this is done by analyzing and processing the high resolution image of the document face.

The invention provides methods and systems for issuing credentials such as identification documents and related methods for verifying such credentials. The invention also provides with attributes used by these methods and systems to enable their verification and reduce fraud. One aspect of the invention relates to issuing a credential, including scanning in documents used to verify the applicant of the credential and creating data records including the image of the documents. As a means to reduce fraud, these data records are linked to the credential and to the issuer location, operator and time and place of issuance. For example, one issuance method includes scanning an image of a document (such as breeder documents) provided by an applicant to verify identity of the applicant, creating a data record associated with the applicant that includes the image of the first document, and issuing the identification document. In one approach, the identification document is linked with the data record by machine readable information in the document.

Another method includes automatically reading machine readable information from the document supplied by the applicant to verify the applicant's identity, and using at least part of the machine readable information from the document to pre-populate a form used to create a credential, such as an identification document.

Another method includes applying a transformation to the image of the first document that enables protection against fraudulent use of the image of the first document. There are a variety of transformations that can be used to secure the image of the document from tampering as well as enabling tracking of the use of the document image to deter fraud. One transformation includes embedding a fragile digital watermark that enables integrity of the image of the first document to be verified. Another transformation includes linking the image to information about the time or place of scanning the image or the operator responsible for handling the image. For example, a digital watermark is embedded in the image that carries this information or carries an index to a database that records this information. Another transformation includes linking the first image to a system that tracks transactions involving the first image. For example, the images may be archived in encrypted form, and all transactions involving handling of the images are tracked by the database that manages the encrypted data. A digital watermark embedded in the image may be used to link it to the database, and in particular, to a transaction log providing information about who accessed the image, the reason for the access, and the time and place. If the image is found to be used in an unauthorized manner, the embedded watermark provides a link to information that can be used by law enforcement to determine who leaked the image, and where and when the image was leaked.

The invention also provides methods for verifying credentials. One such method of verifying a credential comprises reading a physical security feature attribute on the credential, reading a logical attribute on the credential, and comparing information from the physical security feature with the logical storage element on the credential to verify the credential.

### BRIEF DESCRIPTION OF THE DRAWINGS

The foregoing features of this invention, as well as the invention itself, may be more fully understood from the following description and the drawings in which:

FIG. 1 is a high level illustration of an exemplary process for the issuance, manufacture, and authentication of an identification document;

FIG. 2 is a high level illustration of an exemplary process for the issuance, manufacture, and authentication of an identification document, in accordance with a first embodiment of the invention;

FIGS. 3A and 3B are illustrations of various types of security features that an identification document can contain, in accordance with one embodiment of the invention;

FIG. 4 is a high level block diagram of a system for identification document authentication, in a accordance with one embodiment of the invention;

FIG. 5 is a flow chart of a method for authenticating and identification document using the system of FIG. 4, in accordance one embodiment of the invention;

FIG. 6 is a high level block diagram of a system architecture for an identification document capture, issuance, and authentication system, in accordance with one embodiment of the invention; and

FIG. 7 is a high level block diagram of a computer system capable of implementing all or part of the invention.

The drawings are not necessarily to scale, emphasis instead is generally placed upon illustrating the principles of the invention. In addition, in the drawings, like reference numbers indicate like elements. Further, in the figures of this application, in some instances, a plurality of system elements or method steps may be shown as illustrative of a particular system element, and a single system element or method step may be shown as illustrative of a plurality of a particular systems elements or method steps. It should be understood that showing a plurality of a particular element or step is not intended to imply that a system or method implemented in accordance with the invention must comprise more than one of that element or step, nor is it intended by illustrating a single element or step that the invention is limited to embodiments having only a single one of that respective elements or steps. In addition, the total number of elements or steps shown for a particular system element or method is not intended to be limiting; those skilled in the art will recognize that the number of a particular system element or method steps can, in some instances, be selected to accommodate the particular user needs.

### DETAILED DESCRIPTION

Before describing various embodiments of the invention in detail, it is helpful to further explain some terms used herein and explain further some of the environments and applications in which at least some embodiments of the invention can be used.

Identification Documents and Authentication and Verification of Identification Documents

In the foregoing discussion, the use of the word “ID document” or “identification document” or “security document” is broadly defined and intended to include all types of ID documents, including (but not limited to), documents, magnetic disks, credit cards, bank cards, phone cards, stored value cards, prepaid cards, smart cards (e.g., cards that include one more semiconductor chips, such as memory devices, microprocessors, and microcontrollers), contact cards, contactless cards, proximity cards (e.g., radio frequency (RFID) cards), passports, driver's licenses, network access cards, employee badges, debit cards, security cards, visas, immigration documentation, national ID cards, citizenship cards, social security cards, security badges, certificates, identification cards or documents, voter registration and/or identification cards, police ID cards, border crossing cards, security clearance badges and cards, legal instruments, gun permits, badges, gift certificates or cards, membership cards or badges, and tags. Also, the terms “document,” “card,” “badge” and “documentation” are used interchangeably throughout this patent application.). In at least some aspects of the invention, ID document can include any item of value (e.g., currency, bank notes, and checks) where authenticity of the item is important and/or where counterfeiting or fraud is an issue. Those of skill in the art will further appreciate that, instead of ID documents, the inventive techniques can be employed with product tags, product packaging, business cards, bags, charts, maps, labels, etc., etc., particularly those items including marking of an laminate or over-laminate structure. The term ID document thus is broadly defined herein to include these tags, labels, packaging, cards, etc.

Many types of identification cards and documents, such as driving licenses, national or government identification cards, bank cards, credit cards, controlled access cards and smart cards, carry thereon certain items of information which relate to the identity of the bearer. Examples of such information include name, address, birth date, signature and photographic image; the cards or documents may in addition carry other variant data (i.e., data specific to a particular card or document, for example an employee number) and invariant data (i.e., data common to a large number of cards, for example the name of an employer). All of the cards described above will hereinafter be generically referred to as “ID documents”.

In addition, in the foregoing discussion, “identification” at least refers to the use of an ID document to provide identification and/or authentication of a user and/or the ID document itself. For example, in a conventional driver's license, one or more portrait images on the card are intended to show a likeness of the authorized holder of the card. For purposes of identification, at least one portrait on the card (regardless of whether or not the portrait is visible to a human eye without appropriate stimulation) preferably shows an “identification quality” likeness of the holder such that someone viewing the card can determine with reasonable confidence whether the holder of the card actually is the person whose image is on the card. “Identification quality” images, in at least one embodiment of the invention, include covert images that, when viewed using the proper facilitator (e.g., an appropriate light or temperature source), provide a discernable image that is usable for identification or authentication purposes.

Further, in at least some embodiments, “identification” and “authentication” are intended to include (in addition to the conventional meanings of these words), functions such as recognition, applicant verification, information, decoration, and any other purpose for which an indicia can be placed upon an article in the article's raw, partially prepared, or final state. For many issuers and users of identification documents, it may be a requirement that the relevant entity must authenticate the applicant to the degree possible. Such a requirement has guided us as a critical consideration in designing at least some embodiments of the invention. Note that in some instances it may be preferable or desirable to authenticate the applicant before proceeding to capture any information for identification. Further, in other instances it may be necessary for authentication of an applicant after capturing all of the information necessary to issue a document, and in these instances the information gathered during capture and/or authentication can provide additional information to aid law enforcement in the case of applicant fraud.

Applicant verification includes determining that the particular person is eligible for a particular document and they really are who they claim to be. This is often very difficult and error prone step in the process. Verification (i.e. a person is really who he/she claims they are) should include:

What you have, such as credential

What you know, such as background check

What or who you are, such as biometrics

Some types of document issuance systems, such as the central issue systems referred to previously, will generally require a current address in addition to the photograph of the applicant and possibly biometrics of the applicant. In the case of fraud, this information can significantly aid law enforcement.

### Embodiments of the Invention

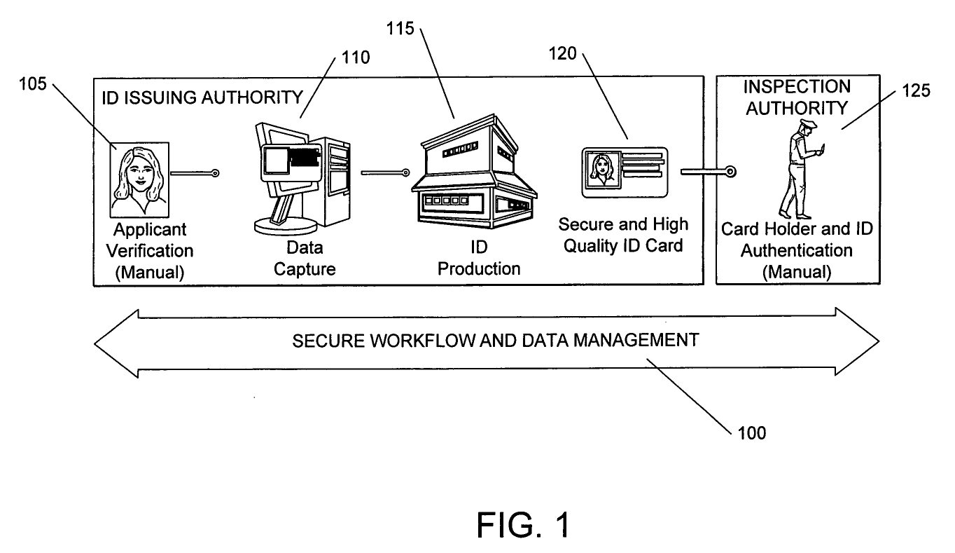

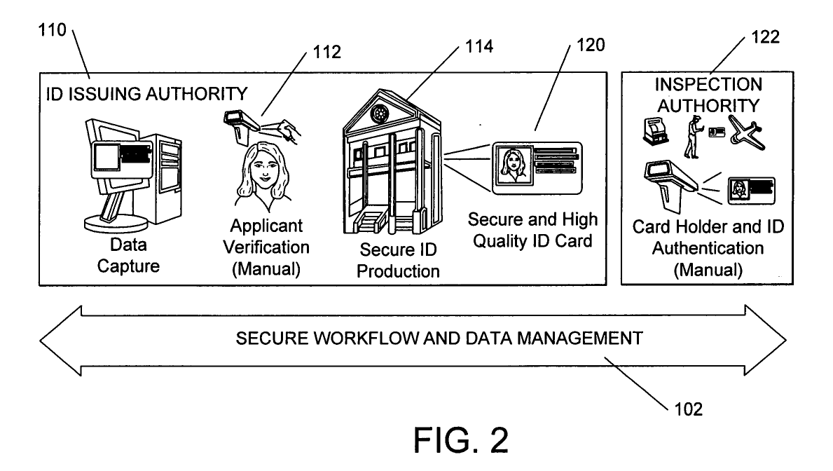

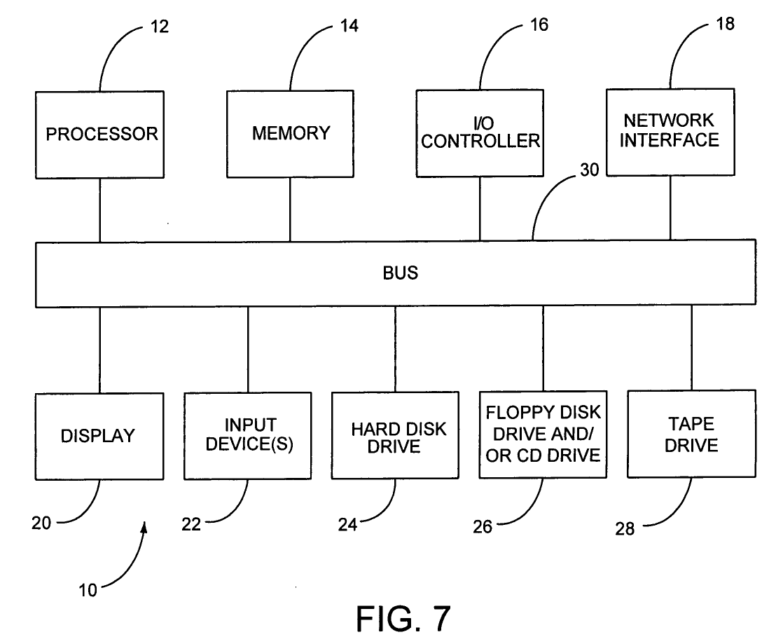

FIG. 2 is a high level illustration of an exemplary process 102 for the issuance, manufacture, and authentication of an identification document, in accordance with a first embodiment of the invention. Comparing the second process 102 of FIG. 2 with the first process 100 of FIG. 1, several important differences can be seen. In FIG. 1, the initial process step was manual verification of an applicant (and/or her credentials), followed by data capture of applicant information. In contrast, in FIG. 2, data capture 110 is the first step in the second process 102, followed by an automatic verification 112 of the applicant (done, e.g., using the system of FIG. 5 and/or the method FIG. 7, each of which is described further herein). In the second process 102 of FIG. 2, the ID production step 116 of FIG. 1 is replaced with a preferably secure ID production step 114 (e.g., a central issuance type of document system), but the invention is not limited to use only with a secure ID production system. As with the first process 100 of FIG. 1, the output goal of the second process 102 is a secure and high quality ID document 120. The inspection authority step of FIG. 2 further differs from that of FIG. 1. In FIG. 2, the card holder and ID authentication 122 is automatic, as compared to the manual card holder and ID authentication of FIG. 1. We expect that hardware, software, systems, methods, and processes implementing embodiments of the invention can be used for step 122 of the process of FIG. 2, as well as step 112 of the process of FIG. 2. Note, however, that the invention is not limited to use only with an automated card holder and ID authentication system.

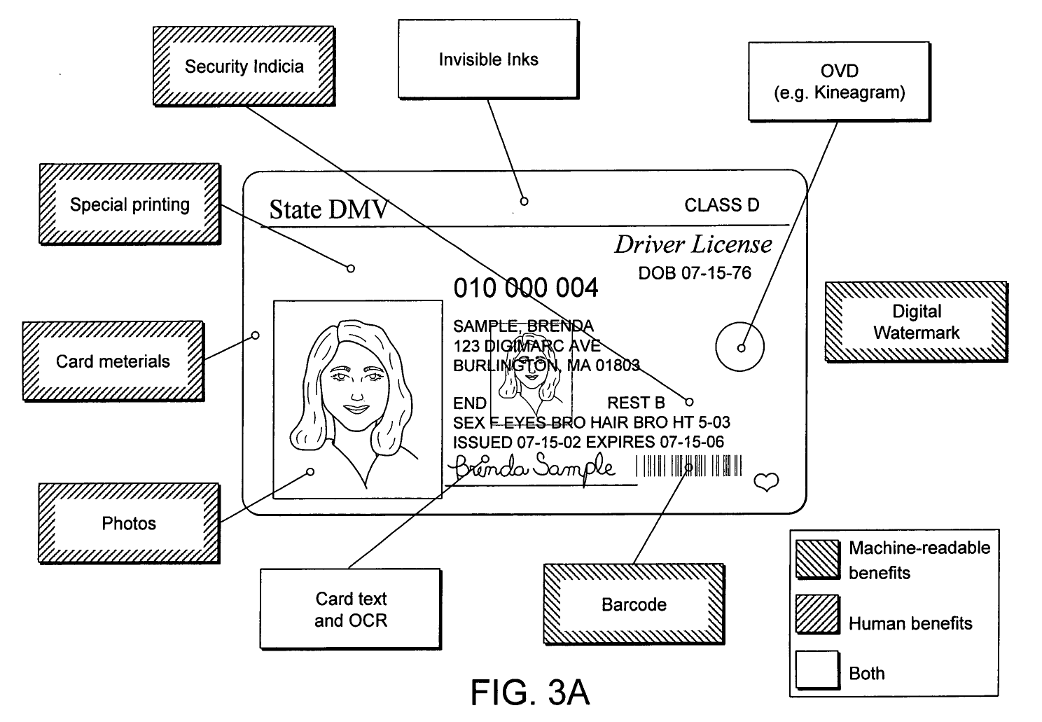

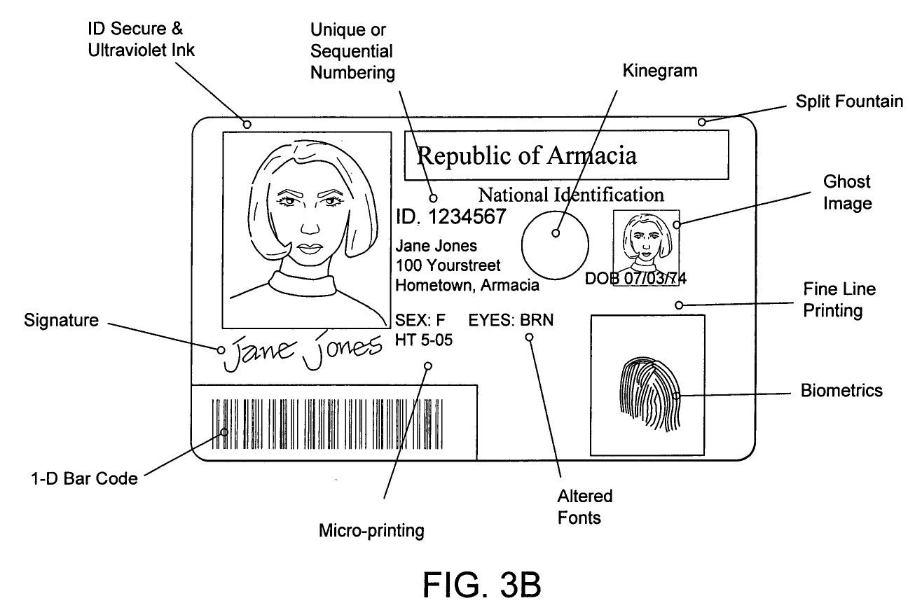

FIGS. 3A and 3B are illustrations of various types of security features that an identification document can contain, in accordance with one embodiment of the invention. FIGS. 3A and 3B are illustrative examples of identification documents available from the assignee of the present invention that can be used with the systems, methods, and devices of at least some embodiments of the invention described herein. As FIGS. 3A and 3B illustrate, ID documents in accordance with at least some embodiments of the invention can combine a wide range of security features and technologies into a layered card that meets customer security requirements within their budgets. Identification documents such as those shown in FIGS. 3A and 3B can use a range of security features including microprinting, optically variable devices, digital watermarking and multicolor UV printing. Many of these security features can be authenticated automatically using the systems and methods described herein.

For optimum security in an identification document, it may be preferable to combine “traditional” types of security features such as:

Security printing to deter casual copying;

Kinegram OVD to deter simulation and easy verification

Microprinting on card and Kinegram to further deter copying

Ghost photo with overlapping text to deter photo swapping and alteration of overlapping text.

The above security features can be automatically authenticated (as described further herein). However, these types of features, at least as presently implemented, do not necessarily provide a data carrying capacity and do not necessarily “tie” or “link” the card to the card holder in any way other than through the photograph, which is human readable. Unfortunately, human verification of security features is subject to many weaknesses, including errors, mistakes, misunderstandings, neglect, deliberate overlooking of problems, insufficient time to properly evaluate all document holders, bribery or other malfeasance or misconduct to influence the person doing the verification, etc. Automated verification can help to overcome at least some of these problems.

Another modification to identification documents that can help deter fraud is use of one or more machine readable and data carrying security elements on an identification document. Examples in accordance with the invention can include (but are not limited to):

2D Barcode with name, date of birth (DOB) driver's license number ( DL#), address, and digital signature (DSA);

Digital watermarking (DWM) to help secure a card from photo swapping and alterations, as well as link together all machine readable security layers via the DL#.

Currently, the most popular data carrying devices used on cards are the magnetic stripe (which can be low capacity, low security and low cost) and the AAMVA Standard PDF417 two dimensional (2D) barcode (medium capacity, some security and very low cost). The PDF417 used as a data carrier has sufficient capacity to contain demographic information, a biometric template, and a Digital Signature (DSA). Unfortunately, it appears that most systems using 2D barcodes do not include any biometric templates (due to interoperability issues) and often do not even include the Digital Signature. The failure to include these simple features makes the 2D barcode one of the most attacked features on current cards.

The 2D barcode does not really have sufficient capacity to store a complete interoperable image of a biometric, only enough for a facial or fingerprint template. This template can provide a very secure tie to the actual cardholder in environments where there is no infrastructure available for online authentication or validation. The addition of a digital signature provides a high level of protection against simulation of the 2D barcode, but might still allow a photocopy of the 2D barcode to function and be validated. One or more digital watermarks can be placed in images that appear on identification documents, with the digital watermark payload including, for example, information relating to the document holder and/or the document itself.

Linked and Layered Security

Layered security, in accordance with at least some embodiments of the invention, is based on using multiple levels of physical and logical security elements in every secure document. The authenticating systems described herein can, in at least some embodiments, work to authenticate linked and layered security documents. For example, an identification document usually contains some visible features such as OVDs (Optically Variable Devices) including special inks, holograms, Kinegrams, etc. Other security features may be less visible, but still verifiable with little or no special equipment. These features include microprinting, UV printing or other special printing techniques. Finally there are features which are hidden from casual view and often only known to the issuer, often called covert (forensic level) features.

So-called “layered” security systems can help to improve security by forcing a counterfeiter to duplicate many security features each using different technologies. Each security feature adds significant difficulty to the counterfeit process. Each security feature can be linked to one or more other security features and/or data on or in the identification document, but not all of these features need to be tied directly to the holder of the identification document. We have found that linking security features together using machine readable techniques and cryptography has the potential to provide a much more secure solution than layered security alone. Linked security makes it substantially impossible for a counterfeiter, or college student, to swap photos, copy 2D barcodes, alter text.

With layered security as implemented in accordance with one embodiment of the invention, only one feature on the identification document (e.g., a portrait) is tied to the identification document holder. We have found that most attacks and simulations of identification documents rely on the ability to copy or simulate enough of the layered security features to get past a casual (typically manual) validation of the card. For example, a common technique is to simulate a card using an inkjet printer and digital photo techniques to get a good simulation of the card face. The 2D Barcode can simply be copied from a valid card, even with a digital signature it will work since it (the digital signature) hasn't been altered. Those of skill in the art readily understand that groups of unauthorized individuals can use technology such as the Internet to share information about simulating and counterfeiting materials and artwork of cards. The good news is that, using machine readable authentication techniques such as those described herein, many, if not all, of these attacks can be detected with using machine readers when linked and layered security techniques are employed.

The technologies of data encryption and digital watermarking have now progressed to the point where these technologies can provide highly reliable linkage of the security elements in a document. For example, we have developed identification documents, in accordance with one embodiment of the invention, where the photograph and background artwork can be designed to contain hidden, machine readable watermarks which are unique on each and every identification document. These two data elements can be verified against the each other and the contents of the 2D barcode located on the back of the card. Because the digital signature protects the 2D barcode against alteration, the linkage of the photo and background art to the 2D barcode, in accordance with one embodiment of the invention, can help to prevent much, if not all, all simulation or counterfeit attacks that would involve swapping photos or using simulated or copied 2D barcodes.

Examples of systems and methods for using a DWM to link information on an identification document can be found, for example, in a commonly assigned U.S. patent application entitled “Uniquely Linking Security Elements in Identification Documents,” Ser. No. 60/488,536, Attorney Docket Number P0853D, inventors Robert Durst, Robert Jones, and Leo Kenen, filed Jul. 17, 2003, which is hereby incorporated by reference. In addition, an example of an additional technique for creating a data storage element for an identification document (or other document) is described in a commonly assigned patent application entitled “Three Dimensional Data Storage,” Ser. No. 10/825,852, Attorney Docket Number P0872D, inventors Robert Jones and Leo Kenen, filed Apr. 16, 2004, which is hereby incorporated by reference. We expressly contemplate the present invention can be combined with and implemented to work with and/or authenticate identification documents made using the above two patent applications, as well as all of the other patents, patent applications, and other patent documents referenced herein.

As we propose herein, verification of a card with linked security features can be performed for at least some embodiments of the invention in an “offline” mode, with relatively low cost imaging devices reading (in one embodiment) only the front of the card. As we describe herein, a reader can verify and validate the following features from by reading a digital watermark embedded in one or more images on the front of the card

Photo and background match (prevents photo swap);

Issuing Agency

Date of birth

ID document number (e.g., DL#)

Using OCR the text on the front can be validated against other elements, this includes the name and the printed DOB

As we further describe herein, in accordance with at least some embodiments of the invention, a system with on-line connectivity can extend this validation to include a match against one or more external databases, thereby providing additional assurance against tampering without (in this embodiment) requiring reading both sides of the card. This allows a system to perform a lookup of data from a server to do 1-to-1 biometric matching using a variety of biometric technologies. Embodiments of the invention that include reading both sides of the card can, of course, include even more evaluation and/or provide alternate evaluations when the front of the identification document includes certain combinations of technologies but not other, as described further below.

The fact that digital watermark linked security has not yet spread to all identification documents does not really present a problem for the validation of identification documents that do not yet contain a digital watermark. While acceptance of the linked technology grows, authentication solutions can be developed based on verification of both sides of the card. An example of such a validation process as used with an identification card, in accordance with one embodiment of the invention, can include the following steps:
1. Image the front of the card and verify that the portrait matches the background via the DWM
2. Read the 2D barcode on the back of the card verifying the digital signature. Note that reading the rear side of the card can be accomplished manually (e.g., the operator manually flips the card) or via a reader capable of imaging two sides of a card. Note that this step and step 1 can be reversed.
3. The DL number read from the DWM and 2D barcode are compared, and if the same the DL is automatically self-authenticated without the inspector looking at any text. In at least some embodiments of the invention, optical character recognition (OCR) is used for further automatic linking.
4. Optionally (if biometrics is being used), data from the watermarks can also be linked to an on-line database to perform 1:1 matching of biometrics to the card holder. This provides another link in the identification structure. The card is linked to the card holder. If an on-line connection to the database is not available a 1:1 matching of a biometric can be implemented for off-line use if a biometric template is stored in the 2D barcode.

In at least some embodiments of the invention, the on-line authentication and verification features can be extended to use a networked authentication and verification proxy to handle the verification of cards which are issued by other jurisdictions. The use of an independent authentication proxy can help provide local control of authentication and allow the local authority to determine which agencies will be queried (local, national or even international). This embodiment of the invention allows validation and approval of requests from other jurisdictions or agencies. In at least one embodiment, a system implemented in accordance with this aspect of the invention uses a secure router that has limited access to each state's database in distributed fashion. In another embodiment, a system implemented in accordance with this aspect of the invention uses a central inter-jurisdiction repository. For more information on cross jurisdiction verification and routers, see U.S. patent Publication 2004-0243567, which is hereby incorporated by reference.

As shown in FIGS. 3A and 3B, in accordance with at least one embodiment of the invention, several layers of machine readable features can be linked with a common data element for cross reference between each machine readable feature. The machine readable features can, for example, include card text via OCR, barcodes (1 and 2D), OVD with readable data (DWM or other), invisible inks providing watermarks or bar codes, magnetic stripes, optical stripes and digital watermarks (one or more in multiple locations). The common data element can, for example, include the DL#, name, initials, DOB, inventory number, document discriminator, biometric data or template (finger, face, iris, etc.), or hash of such an element or each other's data.

With the configurations and linking described above, if one feature is changed, it is conceivable that one would need to change every machine readable features to be evaluated (by the systems, methods, hardware and/or software described herein) because the features can cross-reference each other without human interaction. This increases security because a counterfeiter needs to break every security element, and not just one, and each element requires different expertise and equipment to break. Furthermore, such an implementation of an embodiment of the invention can be designed to protect and links the card, recipient and operator (of the issuer of the identification document). For example, the identification document/card/record can be linked to the issuer's employee (e.g., operator) who processed the identification document, company or location that printed the identification document, etc.

In comparison to the inventive linked and layered system and identification documents described above, some presently available identification documents, such as certain state driver's licenses, put the entire “information payload” in a 2D barcode. Having the whole payload in the 2D barcode, with a digital signature, can help to prevent the alteration of the 2D Barcode itself, but will not tie the barcode to the card or the cardholder. Thus, a counterfeiter could make a photocopy of the barcode and place it on another card, and such an alteration may go undetected. Further, at least in the case of many conventional identification documents, the back or rear side of the document is not usually secured with secure laminates of the type often used on the front of the card. Thus, swapping of the barcodes could turn into a simple and effective way to swap identities in many point of sale or other known machine validated locations. In contrast, linking of a 2D barcode to the photo via digital watermark technology, as described herein for at least one embodiment of the invention, provides a clear-cut, easy to verify linkage and validation of the 2D barcode, while providing an advantage of tying the barcode to the actual cardholder image as well.

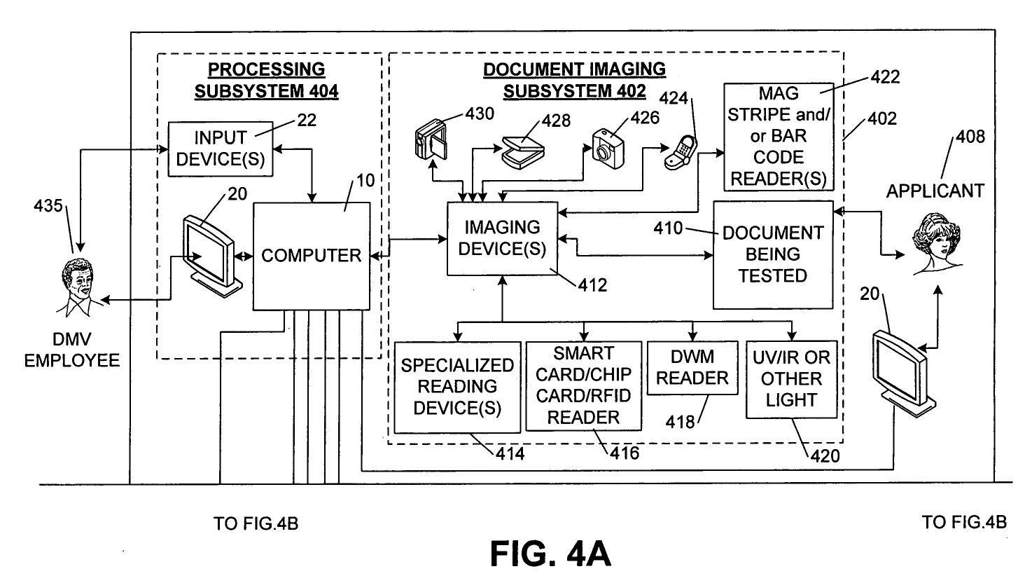

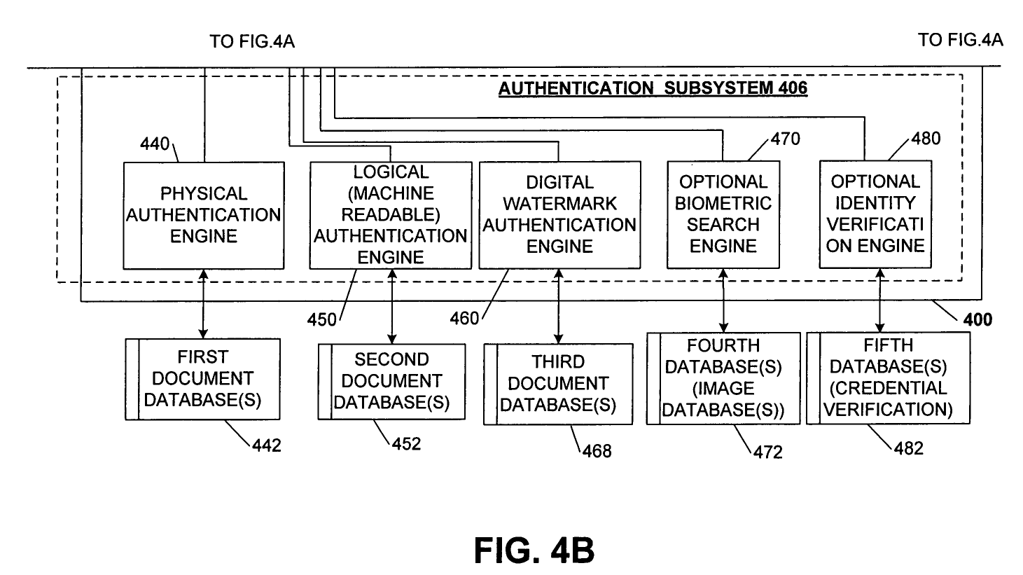

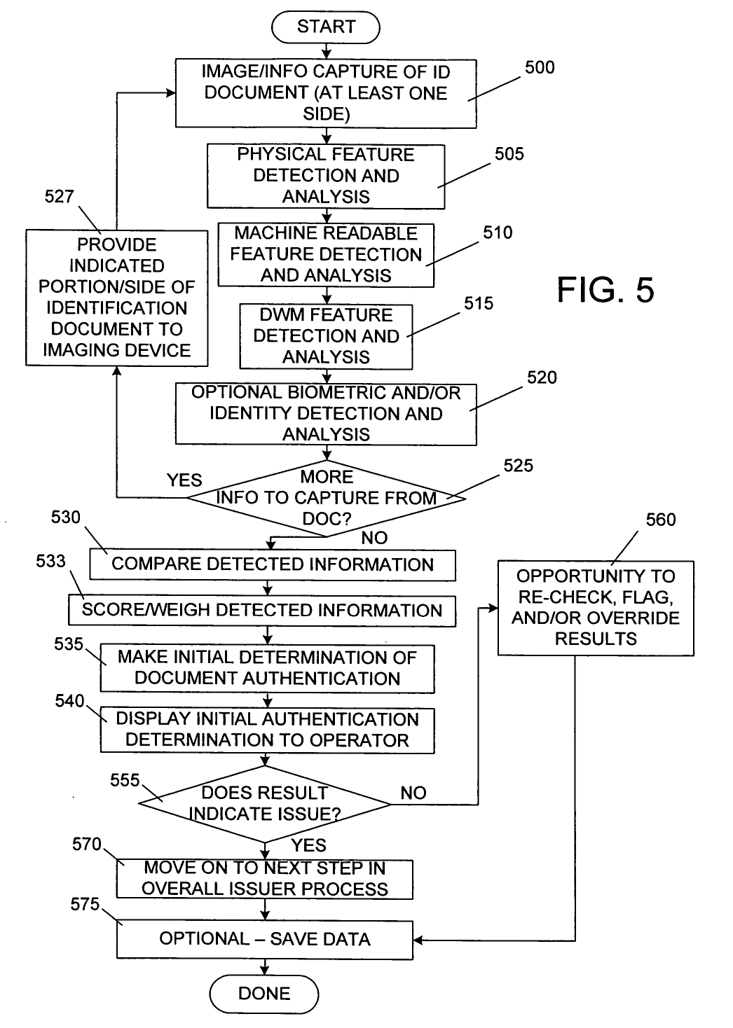

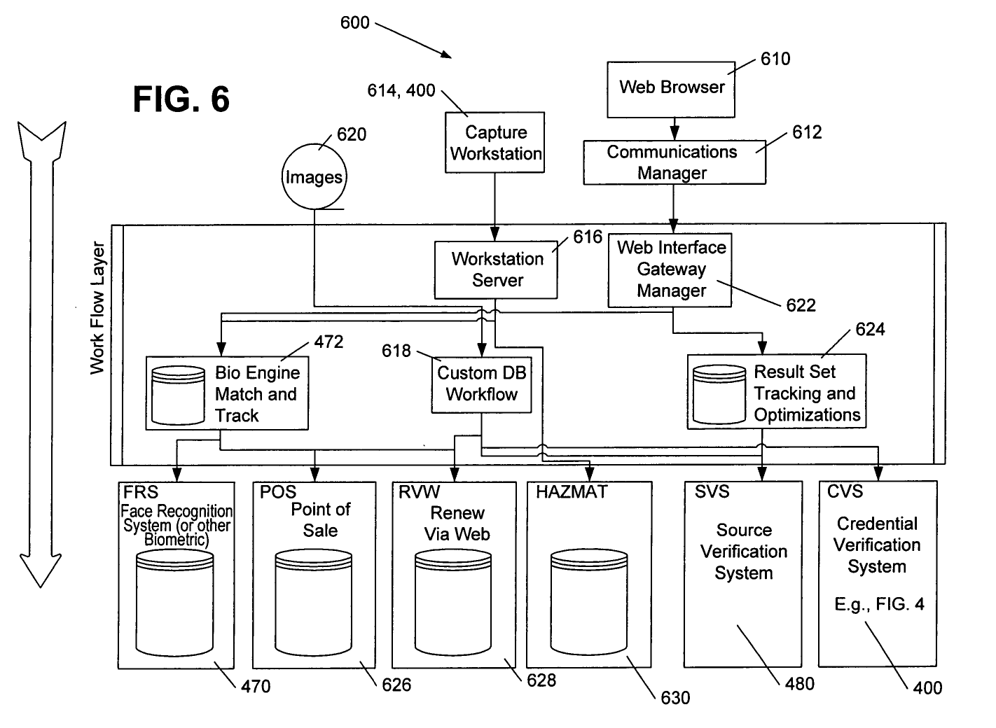

In one embodiment of the invention, we provide a system 400 (illustrated in FIG. 4 and described more fully herein) capable of providing document inspection, document authentication, and/or transaction authentication. Point of inspection/transaction can, for example, include departments of motor vehicles (DMVs), law enforcement, retail stores, point of entry (i.e. port) and online Internet usage. This wide variety of uses makes the many layers of security critical. The goals of the inspection process are can include (but are not limited to) determinations such as determining that the identification document is authentic, determining whether the identification document is valid, and/or determining whether the holder of the identification document is actually the person referenced on the identification document.

FIG. 4 is a high level block diagram of a document verification system 400 for identification document authentication, in accordance with one embodiment of the invention. The system 400 also illustrates at least part of the process flow that occurs during identification document authentication, and can be used to help implement either or both of the application verification 112 and/or the inspection authority 122 of the process 102 of FIG. 2.

Referring to FIG. 4, the document verification system 400 includes three major subsystems: a document imaging subsystem 402, a processing subsystem 404, and an authentication subsystem 406. The document verification system 400 can interact with an applicant 408, an operator 435 (such as a DMV employer or other authorized person checking the document), and a plurality of databases 442, 452, 368, 472, 482 (which provide data for the authentication subsystem 406). It will, of course, be appreciated by those of skill in the art that the document verification system 400 need not be divided into the particular subsystems illustrated in FIG. 4 and that it could, in fact, divided into different subsystems, or could include other subsystems (e.g., a secure ID production subsystem). Further, although the databases 442, 452, 368, 472, 482 are shown as being external to the document verification system 400, any one or more of them could be part of the document verification system, if desired.

In a similar vein, those of skill in the art will readily understand that the document verification system 400 need not be implemented entirely at a single physical or logical location. For example, all or part of the authentication subsystem 406 could be located on a remote server accessible by “clients” such as the processing subsystem 404. Likewise, the document imaging subsystem 402 (which, it should be noted, need not include all the components shown and may be as simple as comprising just a high resolution scanner 428) could be located remotely from the other two subsystems. For example, the document imaging subsystem 402 could be implemented via a stand-alone terminal or kiosk, not unlike an ATM machine, where an applicant 408 could present credentials for remote verification and/or authentication.

Another important note is that the functions in any one or more subsystems of the document verification system 400 could be distributed amongst two or more other subsystems, or implemented entirely in one or more other subsystems. For example, the processing subsystem 404 need not be its own subsystem but could instead be part of (or distributed between) the authentication subsystem 406 and the document imaging subsystem 402. One or more imaging devices 412 in the document imaging subsystem 402 could be part of (or in direct communication with) a particular engine in the authentication subsystem 406 and/or one or more of the databases 442,452,468,472,482. Those of skill in the art will readily appreciate how other functions and elements could be combined and/or re-arranged, within the spirit and scope of the invention.

Referring again to FIG. 4, the document imaging subsystem 402 includes one or more imaging devices 412 capable of acquiring an image of all or part of the document being tested 10. Virtually any imaging device 412 is usable with the invention as long as the imaging device 412 is capable of acquiring an image at a resolution appropriate for the processing subsystem 404 and/or the authentication subsystem 406 to analyze the image. For example, devices that can acquire an image of the document being tested 410 (and/or which can conduct optical character recognition (OCR) on the document being tested 410) include (but are not limited to) so-called mobile “camera phones” 424, digital still cameras 426, scanners 428, and digital video cameras 430. We recognize that not all presently available devices capable of acquiring a digital image of a document have sufficient resolution for all requirements of the processing subsystem 404 and/or the authentication subsystem 406. However, we expect that continual evolutions in technology, as well as the convergence between technologies such as cameras, mobile phones, personal digital assistants (PDA's), MP3 players, will result in future where virtually any type of electronic equipment will someday be capable of acquiring a digital image.

The imaging devices 412 may also include specific devices required to acquire certain physical and/or machine readable information on identification documents. Such devices include (but are not limited to) readers capable of reading a magnetic stripe and/or a bar code (“mag stripe and/or bar code reader(s) 422”), readers capable of communicating with and/or reading a computer chip or radio frequency identification (RFID) on or in the identification document (“smart card/chip card/RFID reader 416”), readers adapted to read a digital watermark (“DWM reader 418”—which could be as simple as a digital camera), and condition control devices 420 which can supply the specific conditions (e.g., UV or IR light or specific temperatures 420) necessary to image or read certain physical and/or machine readable information on the identification document. The reader is presumed to be familiar with such devices and their manufacturers and they are not explained further here.

In one embodiment of the invention the imaging device 412 used is an imaging device capable of acquiring images with a resolution of at least 300 dots per inch (dpi). One manufacturer who can supply such an imaging device is Océ Digital Document Systems (“Océ”) of Boca Raton, Fla. For example, Océ (at the time of filing this patent application) sells the Océ Ds10 high quality document production scanner, which is capable of the required resolution. Océ (via its international office in the Netherlands) also sells many other usable scanners, including, for example, the Océ 3000 microfilm scanner (which can scan at up to 400 dpi) and the Océ ScanStation 650 (which Océ claims can scan at up to 600 dpi). Of course, many other vendors (e.g., Hewlett Packard, Canon, Sharp, etc.) offer technology, such as scanners, capable of scanning document at high resolution. We assume that the reader is familiar with (or can obtain information easily about) the Océ, Hewlett Packard, Canon, Sharp, etc., products, and details of their specifications and operation are not discussed further herein.

Another type of device that we believe can be used as an imaging device 412 includes one or more specialized reading devices 414 that are marketed specifically to image identification documents. Preferably the device is capable of communicating with the processing subsystem 404 and/or the authentication subsystem 406, but that is not require because (as described above), the imaging device 412 could instead include (or be coupled directly two) its own authentication software and/or databases. For example, Intelli-Check of Woodbury, N.Y. presently markets a product known as the ID Check-IDC1400, which Intelli-Check's web site describes as a “standalone, self-contained” terminal that includes software that “is capable of reading the encoding on approximately 180,000,000 IDs in the United States”. Intelli-Check also claims that the IDC 1400 can not only read electronic encoding on U.S. and Canadian driver licenses, identification cards, and military/government IDs, but can also process magnetic stripes and ID and 2D bar codes. We assume that the reader is familiar with (or can obtain information easily about) Intelli-Check's products, and details of their specifications and operation are not discussed further herein.

Although the Intelli-Check ID1400 could be used, in at least some embodiments of the invention, as a specialized reading device 414 (and a mag stripe reader 422) in the document imaging subsystem, to perhaps perform a subset of authentication tasks, we have found that it may be preferable in at least some embodiments of the invention to use devices (such as the above-described Océ scanners) in combination with software and systems where the combination can be configured to acquire information and provide it to the authentication subsystem 406 and processing subsystem 404 for further analysis. For example, AssureTec Systems, Inc. of Manchester, N.H. presently offers a product called the i-Dentify™ reader-authenticator and associated AssureID™ software platform, which can be used in at least some embodiments of the invention to accomplish multiple functions of the document imaging subsystem 402 as well as functions done by the processing subsystem 404 and by some of the engines in the authentication subsystem 406. For example, AssurTec's web page states that the i-Dentify™ reader-authenticator and associated AssureID™ software platform can provide full page color image capture, UV and IR lighting, OVD inspection/suppression and lighting, and document type identification, data capture, and document authentication. AssureTec also offers an Identification Reference Library™ which AssurTec claims works with the AssureID™ to direct and conduct specific capture and authentication checks. We assume that the reader is familiar with (or can obtain information easily about) AssureTec's products, and details of their specifications and operation are not discussed further herein.

Still another specialized reading device 414 that may be usable with some embodiments of the invention is the IA-thenticate™ which is available from Imaging Automation of Bedford, N.H. The IA-thenticate™ is available with and without its own integrated personal computer. Imaging Automation claims that its IA-thenticate™ is a hardware/software platform that includes varying light sources to help perform multiple security checks. In addition, Imaging Automation claims that its IA-thenticate™ can perform functions such as verifying an MRZ checksum, confirming the presence of a particular ink type (B900 ink), as well as capturing and analyzing information contained in various types of identification documents. Like the above-described AssureTec products, the Imaging Automation IA-thenticate™ can be used in at least some embodiments of the invention to accomplish multiple functions of the document imaging subsystem 402 as well as functions done by the processing subsystem 404 and by some of the engines in the authentication subsystem 406. We assume that the reader is familiar with (or can obtain information easily about) Imaging Automation's products, and details of their specifications and operation are not discussed further herein.

One device that can be used as a combination bar code and mag stripe reader 422 is the IDLogix C100 hand held terminal, available from Concord EFS of Memphis, Tenn. Concord EFS states on its web site (www.concordefs.com) that its IdLogix C100 terminal works with its IDLogix^{SM} service to “instantly read and validate” information such as data contained within a two dimensional bar code and/or a magnetic stripe. In at least one embodiment of the invention, the IDLogix C100 hand held terminal and the IDLogix^{SM} service can be used in at least some embodiments of the invention to accomplish multiple functions of the document imaging subsystem 402 as well as functions done by the processing subsystem 404 and by some of the engines in the authentication subsystem 406. We assume that the reader is familiar with (or can obtain information easily about) Concord EFS's products, and details of their specifications and operation are not discussed further herein.

Referring again to FIG. 4, the processing subsystem 404 includes a computer 10, which computer may include one or more input devices (e.g., keyboard, pointing device, touch screen, etc.) and/or a display 20 for communication with the DMV employee 435. The computer 10 helps in a determination of document authenticity in several ways, including receiving data from the authentication subsystem 406, providing the data as needed to the authentication subsystem 406, receiving analysis information back from the authentication subsystem, and applying a weighting, comparison, and/or other further analysis to help provide a determination of document authenticity and/or validity. In at least one embodiment, the computer 10 helps to implement the method of FIG. 5 (which is described further herein).

FIG. 7 is a high level block diagram of computer system 10 capable of implementing all or part of the invention, and provides more details about the computer system 10. Those of skill in the art will appreciate that systems and methods described herein in accordance with various embodiments of the invention can be implemented using any type of general purpose computer system, such as a personal computer (PC), laptop computer, server, workstation, personal digital assistant (PDA), mobile communications device, interconnected group of general purpose computers, and the like, running any one of a variety of operating systems.

Referring briefly to FIG. 7, the computer system 10 includes a central processor 12, associated memory 14 for storing programs-and/or data, an input/output controller 16, a network interface 18, a display device 20, one or more input devices 22, a fixed or hard disk drive unit 24, a floppy disk drive unit 26, a tape drive unit 28, and a data bus 30 coupling these components to allow communication therebetween.

The central processor 12 can be any type of microprocessor, such as a PENTIUM processor, made by Intel of Santa Clara, Calif. The display device 20 can be any type of display, such as a liquid crystal display (LCD), cathode ray tube display (CRT), light emitting diode (LED), and the like, capable of displaying, in whole or in part, the outputs generated in accordance with the systems and methods of the invention. The input device 22 can be any type of device capable of providing the inputs described herein, such as keyboards, numeric keypads, touch screens, pointing devices, switches, styluses, and light pens. The network interface 18 can be any type of a device, card, adapter, or connector that provides the computer system 10 with network access to a computer or other device, such as a printer. In one embodiment of the present invention, the network interface 18 enables the workstation 10 to connect to a computer network such as the Internet.

Those skilled in the art will appreciate that computer systems embodying the present invention need not include every element shown in FIG. 7, and that equivalents to each of the elements are intended to be included within the spirit and scope of the invention. For example, the computer system 10 need not include the tape drive 28, and may include other types of drives, such as compact disk read-only memory (CD-ROM) drives. CD-ROM drives can, for example, be used to store some or all of the databases described herein.

In at least one embodiment of the invention, one or more computer programs define the operational capabilities of the workstation 10. These programs can be loaded into the computer system 10 in many ways, such as via the hard disk drive 24, the floppy disk drive 26, the tape drive 28, or the network interface 18. Alternatively, the programs can reside in a permanent memory portion (e.g., a read-only-memory (ROM)) chip) of the main memory 14. In another embodiment, the workstation 10 can include specially designed, dedicated, hard-wired electronic circuits that perform all functions described herein without the need for instructions from computer programs.

In at least one embodiment of the present invention, the computer system 10 is networked to other devices, such as in a client-server or peer to peer system. For example, referring to FIG. 4, the computer system 10 can be networked with the document imaging subsystem 402 and the authentication subsystem 406. The computer system 10 can, for example, be a client system, a server system, or a peer system. In one embodiment, the invention is implemented at the server side and receives and responds to requests from a client, such as a reader application running on a user computer.

The client can be any entity, such as a the workstation 10, or specific components thereof (e.g., terminal, personal computer, mainframe computer, workstation, hand-held device, electronic book, personal digital assistant, peripheral, etc.), or a software program running on a computer directly or indirectly connected or connectable in any known or later-developed manner to any type of computer network, such as the Internet. For example, a representative client is a personal computer that is x86-, PowerPC., PENTIUM-based, or RISC-based, that includes an operating system such as IBM.RTM, LINUX, OS/2 or any member of the MICROSOFT WINDOWS family (made by Microsoft Corporation of Redmond, Wash.) and that includes a Web browser, such as MICROSOFT INTERNET EXPLORER, NETSCAPE NAVIGATOR (made by Netscape Corporation, Mountain View, Calif.), having a Java Virtual Machine (JVM) and support for application plug-ins or helper applications. A client may also be a notebook computer, a handheld computing device (e.g., a PDA), an Internet appliance, a telephone, an electronic reader device, or any other such device connectable to the computer network.

The server can be any entity, such as computer system 10, a computer platform, an adjunct to a computer or platform, or any component thereof, such as a program that can respond to requests from a client. Of course, a “client” can be broadly construed to mean one who requests or gets the file, and “server” can be broadly construed to be the entity that sends or forwards the file. The server also may include a display supporting a graphical user interface (GUI) for management and administration, and an Application Programming Interface (API) that provides extensions to enable application developers to extend and/or customize the core functionality thereof through software programs including Common Gateway Interface (CGI) programs, plug-ins, servlets, active server pages, server side include (SSI) functions and the like.

In addition, software embodying at least some aspects of the invention, in one embodiment, resides in an application running on the workstation 10. In at least one embodiment, the present invention is embodied in a computer-readable program medium usable with the general purpose computer system 10. In at least one embodiment, the present invention is embodied in a data structure stored on a computer or a computer-readable program medium. In addition, in one embodiment, an embodiment of the invention is embodied in a transmission medium, such as one or more carrier wave signals transmitted between the computer system 10 and another entity, such as another computer system, a server, a wireless network, etc. The invention also, in at least one embodiment, is embodied in an application programming interface (API) or a user interface. In addition, the invention, in at least one embodiment, can be embodied in a data structure.

Note that the system 10 of FIG. 7 is not limited for use with a single computer. Some or all of the computer system 10 can, of course, be used for various types of processing taking place in the systems described herein, as will be appreciated by those skilled in the art. Further, in at least some embodiments, a plurality of computer systems 10 can be arranged as a parallel computing system. In still further embodiments (as previously mentioned) functionality equivalent to that of the computer system 10 can be provided by one or more devices that are part of the document imaging subsystem 402 and/or the authentication subsystem 406.

It should be appreciated that any one or more of the elements illustrated in the embodiments described herein may be located remotely from any or all of the other elements, and that any of the elements of a given embodiment may, in fact, be part of another system altogether. For example, a database accessed by one or more of the elements of a given embodiment may be part of a database maintained by an organization entirely separate from the system of the invention.

Referring again to FIG. 4, the authentication subsystem 406 of the document verification system 400 includes one or more engines (which may be implemented via hardware, software, or a combination thereof) for conducting authentication. As noted previously, some types of imaging devices (e.g., the AssureTec i-Dentify™ reader-authenticator and associated AssureID™ software platform) provide certain functionality equivalent to one or more of the engines. In some instances commercially available products (including both hardware and software) are available to be integrated with the document verification system to provide authentication and/or analysis of certain features. Such products may be designed to communicate with separate databases or may (like the Intelli-Check product) include their own databases. For example, one commercially available product that can be used as part of the authentication subsystem 406 is the IDLogix^{SM} service available form Concord EFS of Memphis, Tenn. In at least one embodiment of the invention, proprietary and custom engines are developed by the assignee of the present invention to accomplish one or more of the engines in the authentication subsystem 406.

The physical authentication engine 440 receives captured image information about the physical attributes/characteristics (as explained previously) of an identification document, analyzes the physical characteristics of identification documents and compare the physical characteristics to a first document database 442 (which can, for example, be an extensive, continuously updated database of documents). The physical authentication engine 440 helps to determine whether such features are appropriate given the type and issue date of the identification document, and also whether such features are properly implemented. In at least some embodiments, the physical authentication engine 440 works with the processing subsystem and the document imaging subsystem 402 to use advanced pattern and color matching techniques to detect advanced security features and other known characteristics to verify the authenticity of documents. The physical authentication engine 440 can help with initial characterization of identification documents via sophisticated document recognition techniques (e.g., “this document appears to be a Georgia Driver's License”), eliminating the need for manual operator, selection of document type.

For example, in at least one embodiment of the invention, the physical authentication engine 440 may receive one or more images corresponding to the front side of a California driver's license. The physical authentication engine 440 communicates with the first database 442 to determine via certain physically visible data fields that the image is indicating that it is a California driver's license, based on that would look for the issuance date field and would determine (e.g., via OCR of issue date) the particular format of the license, and based on that format, and would look in the received image for certain features (e.g., certain optically variable indicia that are part of the overlaminate of driver's license). If the specific visible features were not visible in the received image, the physical authentication engine 440 might send a message (e.g. via the computer system 10) to the document imaging subsystem 402 instructing it to capture a specific image of the identification document (e.g., an image as illuminated by UV light). Alternately (or in addition), the physical authentication engine 440 might send a message to the DMV employee 435, via the computer system 10, to instruct the DMV employee 435 to control the document imaging subsystem 402 to capture a certain image and/or to re-test the document being tested 410. In at least one embodiment of the invention, the physical authentication engine 440 could instead send such a message or instruction to the applicant 408, via the processing subsystem 404 and an applicant display 20.

As will be described more fully herein, a determination by the physical authentication engine 440 (in cooperation with the processing subsystem 404) that physical attributes are “OK” for a given identification document will not necessarily mean that the identification document is fully authenticated. Other levels of authentication, including but not limited to machine readable authentication, digital watermark authentication, biometric authentication, and/or identity verification, may still need to occur. At least some embodiments of the invention use, compare, and weight the results (if available) from each authentication engine as part of a determination of document validity.

Referring again to FIG. 4, the logical authentication engine 450 (also referred to as the machine readable authentication engine) works with the document imaging subsystem 402 and the processing subsystem 404 to capture all bar code and MRZ information, preferably directly from the high resolution images of the document acquired by the document imaging subsystem 402. In one embodiment, the logical authentication engine 450 works together with the processing subsystem 404 to perform optical character recognition (OCR), not only on text contained in the MRZ, but also on plain text (e.g., printed document number and birth date) contained on the document face. The logical authentication engine also can receive magnetic strip information read via a mag stripe reader 422, to help authenticate that information. In at least one embodiment, the logical authentication engine 450 decodes and authenticates substantially all machine readable data on the identification document (with possible exception of the digital watermark). For example, the logical authentication engine 450 can examine data contained in a document MRZ to analyze for checksum digit accuracy and can further compare such data to other data (e.g., physical data, other machine readable data, digital watermarks) that is extracted from and/or detected on the identification document 410. These types of comparisons can take full advantage of the linked and layered identification document aspect of the invention that we described previously.

In one embodiment, the logical authentication engine 450 compares the information contained in bar codes and magnetic stripes for content and format accuracy to a second document database 452, which can, for example, be a constantly updated database of existing identification documents (e.g., existing US and Canadian DL/ID cards.).

The logical authentication engine 450 can include specific software and/or hardware for processing certain specific machine readable information captured by the document imaging subsystem 402. For example, Positive Access Corporation of Eden Prairie, Minn. provides a software product called CardChecker™ that Positive Access claims provide the ability to read and decode the digital information from the magnetic stripe and 2D bar code on state-issued driver's license cards. The CardChecker™ product can receive information scanned by, e.g., a bar code and/or mag stripe reader 422 and can be used in at least some embodiments of the invention as part of the logical authentication engine 450 and second document database 452. We assume that the reader is familiar with (or can obtain information easily about) Positive Access's products, and details of their specifications and operation are not discussed further herein.

Referring again to FIG. 4, the digital watermark (DWM) authentication engine 460 receives the high resolution image of the document from the document imaging subsystem 402 and analyzes and processing the high resolution image of the document face to help verify the presence and/or absence of digital watermarking on the identification document. The digital watermark authentication engine 460 may also include advanced logic that can determine whether the identification document being tested 410 should include an embedded DWM and can read the DWM to verify its contents and check the contents against a third document database 468 and/or other information on the document. The third document database 468 can, for example, include a look-up table of watermarking schemes or methods associated with particular features on cards, watermark payload information, etc.

In at least some embodiments of the invention, the digital watermark authentication engine 460 and its document database 468 can implement technologies described in one or more of the following commonly assigned U.S. patents and patent applications, each of which is hereby incorporated by reference:
Identification Document and Related Methods (Application No. 10/686,595 filed Oct. 14, 2003, Attorney Docket No. P0895D—Inventors Burt Perry, Trent Brundage, Mahmood Sher-Jan, Brett Hannigan, Robert T. Durst, Jr., Matthew Weaver, Brett Bradley, and John Stach;
Method and System for Recognizing Security Documents (U.S. Pat. No. 6,674,886, issued Jan. 6, 2004, inventors Bruce L. Davis et al.);
Watermark Embedder and Reader (U.S. Pat. No. 6,614,914, issued Sep. 2, 2003, inventors Geoffrey B. Rhoads et al.);
Printing and Validation of Self Validating Security Documents (U.S. Pat. No. 6,389,151, issued May 14, 2002, inventors Jonathan Scott Carr et al.);
Security System for Photographic Identification (U.S. Pat. No. 5,841,886, issued Nov. 24, 1998, inventor Geoffrey B. Rhoads); and
Computer System Linked by Using Information in Data Objects (U.S. Pat. No. 6122403, issued Sep. 19, 2000, inventor Geoffrey B. Rhoads).

Referring again to FIG. 4, as an additional option in at least some embodiments of the invention, the document authentication system 400 can include a biometric search engine 470 which can communicate with one or more biometric databases 472. We have found that the process of matching the identification document holder to the identification document itself can be the most frequently “ignored” part of a complete identification system. In virtually all current present implementations of identification systems, matching the identification document holder to the identification document itself is done by simply having a person look at the photo printed on the document and then at the card holder. The person doing the comparison has the complete burden of performing the matching function. This method has obvious disadvantages especially because, as we have noted previously, humans make mistakes, can get fatigued, can provide inattention and neglect, can be subject to unlawful interference.

In contrast, automated biometric identification systems, such as facial and/or fingerprint matching systems, have become quite accurate, and these systems are generally not vulnerable to bribes or other human fraud. The biometric search engine 470 can, for example, be implemented by using 1:1 biometric comparisons between an image provided by the document imaging subsystem 402 and an image stored in the fourth database 471. The use of 1:1 facial recognition is not intrusive can help to reduce identification document errors and fraud significantly. A lower cost alternative for 1:1 matching of a biometric is to use a low cost fingerprint scanner (e.g., add a fingerprint scanner (not shown in FIG. 4) to the document imaging subsystem 402) and use a fingerprint biometric (with a database of fingerprints 472). A fingerprint-based implementation can be cheaper and more accurate than the facial biometric implementation, but it is possible that use of fingerprints for this purpose may encounter greater resistance from the public.

Typically, 1:1 facial matching requires taking a photo of the person, extracting this live template, and comparing it to a template stored on the ID card or a template created from the digital photo data stored on the ID card. 1:1 facial matching can, however, be implemented using existing photos. The template can be stored in the 2D barcode or chip on the card. With presently available technology, digital photo data must be stored on a chip because there's too much data for the 2D barcode. Fingerprinting operates very similarly.

It also is possible to implement the biometric search engine 470 as one to many type of facial recognition system, which searches a database of images for a match to a given image. Both 1:1 and 1:many biometric search engines are presumed to be known to those of skill in the art and details on these technologies are not provided here. The reader is encouraged to review the following commonly assigned patent applications, which detail implementations of biometric search systems that can be advantageously used with at least some embodiments of the invention:
Systems and Methods for Managing and Detecting Fraud in Image Databases Used With Identification Documents (Application No. 10/723m240, Attorney Docket No. P0910D, filed Nov. 26, 2003—Inventors James V. Howard and Francis Frazier);
Systems and Methods for Recognition of Individuals Using Multiple Biometric Searches (Application No. 10/686,005, Attorney Docket No. P0900D—Inventors James V. Howard and Francis Frazier);

Referring again to FIG. 4, still another optional engine in the authentication subsystem 406 is an identity verification engine 480. An identity verification engine 480, such as the ChoicePoint Authentication Service offered by ChoicePoint of Alpharetta, GW, can compare the specific content of information acquired by the document imaging subsystem 204 to databases of information (e.g., the fifth database 482) to establish credential verification. For example, ChoicePoint indicates that its Authentication Service can verify information such as name, Social Security number, date of birth, and driver's license number (e.g., by checking government and/or private databases 482 of such information). The ChoicePoint Authentication service also verifies information by posing questions to an applicant that typically only the “real” applicant can answer, such as what years an applicant lived at a particular past address. With an identity verification engine 480 similar to the ChoicePoint system, the identity verification engine 480 can communicate such queries to the applicant 408 via the processing subsystem 404 and the applicant display 20. Alternately, the identity verification engine 480 could communicate such a query (also via computer the processing subsystem 404 and via the DMV display 20) to the DMV employee 435, who could then manually ask the applicant such questions.

Those of skill in the art will appreciate that the authentication subsystem 406 and/or the various databases that it communicates with could, for example, be part of another identification document issuing jurisdiction instead of a central repository (in the databases, e.g.) of identification document information. For example, the document authentication system 400 can be coupled to a router (not shown) that security distributes requests to appropriate jurisdiction for validation and local protection of private data.

The document verification system 400 of FIG. 4 can be readily adapted to conduct automated authentication of documents from other jurisdictions, especially if online connectivity is available. In a simple embodiment of this aspect of the invention, the document imaging subsystem 402 need only read jurisdiction, DL number and other linkage data from machine readable data on the card (e.g., a digital watermark, a smart card chip, an optical write only media, a 2D barcode, etc.) and transmit that data to a an authentication server (e.g., a remote authentication subsystem 406). Law enforcement personnel may find this aspect of the invention especially useful. For example:

When presented with an identification document that contains one or more digital watermarks, law enforcement can easily verify and authenticate the document by scanning/imaging the identification document such that the DWM is properly imaged The DWM provides automatic self-authentication, and device that read the DWM can securely (perhaps even wirelessly) transmit the DL number, read from the DWM, to a remote system for validity/

Any machine readable technology 2D barcode data can be read when presented with ID card with a wire less handheld or laptop device which can verify the card holder's identity via secure communications with a remote system.

In an advantageous embodiment of this aspect, such a remote system has inter-jurisdictional access, but respects privacy (i.e. not be a central repository of state information). If the data is from the local jurisdiction, the police server will authenticate the data and validated any necessary links. In the case of a non-local jurisdiction, the data would be securely forwarded directly to that jurisdiction or a document validation clearing house, which would reply with a true/false response using secure protocols. In the case where the validation is being performed directly by the other jurisdiction, that jurisdiction can validate the identity of the querying authority (e.g., by using an x509 certificate) and can track access to that particular identification record without ever loosing direct control of the card holder's data, thus protecting the privacy of the card holder.

As stated above, this aspect of the invention can use a secure router which has limited access to each jurisdiction's database in distributed fashion, as opposed to a central inter-jurisdiction repository (as some agencies such as the American Association of Motor Vehicle Administrators (AAMVA) have proposed). Such a distributed embodiment of the invention can have more advantages than merely. This system permits some segments or data sites to be down without affecting the performance of the remainder of the system and would allow upgrades and changes to be made by any jurisdiction without affecting the other jurisdictions in any way. Another benefit of a distributed system is the ability to use biometric templates on cards or in database with the matching engines (of various independent vendors) to be located within the jurisdiction of the data holder, permitting simple maintenance and control of the matching systems.

FIG. 5 is a flow chart of a method for authenticating and identification document using the system of FIG. 4, in accordance one embodiment of the invention. Referring to both FIGS. 4 and 5, the method begins by imaging at least one side of an identification document that is presented to the document imaging subsystem 402 (step 500). The document imaging subsystem 402 and the authentication subsystem 406 detect and analyze the relevant features on the identification document (e.g., physical attributes (step 505), machine readable attributes (step 510) , DWM attributes (step 515), biometric attributes (step 520) and/or identity verification attributes (step 520)). Depending on the format of the given identification document, on the side being viewed, and on the particular imaging device 12 providing the information, not all of the detection steps 505 through 520 will be performed. In addition, it will be appreciated that steps 505 through 520 can, in at least some embodiments of the invention, be performed in any order.

If, based on the detected and analyzed features, additional information needs to be captured from the identification document (step 525), then an applicant 408 and/or the DMV employee 435 is prompted (step 527) to provide the indicated portion of side of the identification document to the document imaging subsystem 402. Alternately, if the identification document is still in place in the document imaging subsystem 402, the document imaging subsystem 402 may simply re-image the data itself automatically (if possible). For document imaging subsystems that are capable of imaging more than one side of a document at a time, such a prompt may never occur.

The prompt arising from step 525 can occur for many reasons. For example, the document imaging subsystem 402, processing subsystem 404 and/or authentication subsystem 406 may detect a bad or incorrect “read” of the relevant data. The document imaging subsystem 402 may require that the identification document be changed from one type of imaging device to another (e.g., from a scanner 428 to a mag stripe reader 422). Another reason may be that the processing subsystem 404 has determined or detected inconsistencies between data detected and analyzed by one or more of the engines in the authentication subsystem 406 (this comparison step can be similar to the comparison step 530 described below).

When all data is captured from the identification document (step 525), the processing subsystem 404 compares the detected information (step 530) and scores and/or weighs the detected information (step 533), in some instances ranking the output of one authentication engine over the output of another. The remaining steps may be best understood in the context of a specific example. In this example, assume that an identification document is presented listing an Applicant “Crystal Kitty” having a printed birthdate of 2/8/1965 and having a digital photographic image of Crystal Kitty printed thereon. The identification document also has printed thereon a covert digital image of Crystal Kitty printed in full color UV ink (as described, for example, in commonly assigned patent application entitled “Covert Variable Information on Identification Documents and Methods of Making Same” (Application No. 10/330,032, Attorney Docket No. P0732D, filed Dec. 24, 2002—Inventors Robert Jones and Daoshen Bi, which is hereby incorporated by reference);

The face of the identification document is imaged, in both visible and ultraviolet light (step 500). Based on the output of steps 500-525, the processing subsystem may note, based on the data from the authentication subsystem 406, that the 2D barcode is properly present on the identification document and that it lists a birthdate of Feb. 8, 1965, which matches the printed birthdate that was detected (via OCR) on the identification document. However, a digital watermark embedded in the visible digital photographic image of “Crystal Kitty” lists a different birthdate (July 5, 1984) than was printed on the document.

The processing subsystem 404 and the physical authentication engine 440 determine (step 53) that the visible digital photographic image of Crystal Kitty substantially matches the covert (ultraviolet) image of Crystal Kitty. The processing subsystem 404 can compare the information from the various engines, scoring and/or weighting them, to determine which information is likely to be the most correct and/or “reliable (step 533). In this example, information from the physical authentication engine 440 (OCR birthdate of 2/8/1965, visible and covert images) is compared with information form the machine readable engine 450 (2/8/1965 in 2D barcode) and with information detected by the DWM engine 460 (7/6/1984) so that the processing subsystem 404 can make a decision as to which information, if any, is decisive for authenticating the identification document (step 535).

In this example, the processing subsystem 404 determines that, despite the fact that certain data from the physical authentication engine 440 and the logical authentication engine 450 agree on a birthdate of 2/8/1965, the DWM information, in combination with certain other physicals data, is determined to be the most reliable and “true” information. This decision is based on decision logic implemented in the processing subsystem 404 of specific embodiment which states that certain information (e.g., digital watermarks, covert variable data such as UV portraits) is inherently reliable because it is much more difficult to alter or simulate or replace (in contrast with 2D bar codes and other printed data, which can be forged using a computer and a printer, or via cut and paste).

In this example, because the visible digital photographic portrait matched the covert photographic portrait, the processing subsystem 404 determines that information associated with the digital photographic portrait and/or with the covert photographic portrait score “higher” on an index of reliability than some other information on the identification document. Thus, a digital watermark extracted from the digital photographic portrait will be scored higher than (and be given a greater decision-making “weight”) than other information on the identification document. As a result of this rule, the processing subsystem 404 makes a determination that birthdate of 7/6/1984 is the “true” birthdate of Crystal Kitty and that, because the information detected elsewhere on the document does not match this, the document is not authentic (step 540). The operator (e.g., DMV employee 435) is given this information (step 540) and given an option (step 555) of what to do about it. In this example, the DWV employee 435 may decide to re-check the results (in case a bar code or birthdate was scanned incorrectly), flag the results for future use, override the results, etc. (step 560). The DMV employee 435 may also decide to not issue the identification document.

This flexibility in giving an operator some control can be advantageous to prevent the inconvenience of being denied an issuance if the fault was with the imaging subsystem 402 or another subsystem. In addition, even if the operator fraudulently overrides the automated decision (step 535) that a document is not authentic, the particular overriding can be directly traced to the operator. The data can be stored for future use (step 575).

If there were no problems with the checks performed on the identification document (step 555), the applicant and/or DMV employee can move on to the next step in the document issuance process (step 570), such as document production, and the information can be saved (step 575).

Additional Illustrative Examples

Driver's License Authentication The next example embodiment is one where an applicant presents a driver's license (DL) as an identity document during the application process. To begin the process, the operator simply places the DL into the appropriate equipment in the document imaging subsystem (e.g., face down on the platen of a scanner or reader). The DL card is automatically detected and the reader images the front of the card (step 500) as described above, in the visible, UV, and IR light spectrums. These images are sent to the processing subsystem 505 and the processing subsystem 404 and authentication subsystem 406 begin an analysis of the DL. In this illustrative example, the first step completed in the analysis is a sophisticated document recognition that provides an initial determination of the type of document. Having completed this initial step, the processing subsystem 404 and authentication subsystem 406 further detects and isolates specific features (i.e., security features and other physical characteristics) on the document face (visible in the different wavelengths of light) which are used to verify authenticity of the card (steps 505, 510). In addition to physical features of the card, certain important data fields, such as name, birth date, and issue or expiration date, can be extracted using OCR techniques. The visible light image of the card is also scanned for the presence (or absence) of a digital watermark (step 515)

When this level of analysis is complete, the operator will be prompted to turn the DL card over (step 527). The operator will remove the card from the platen and replace it with the back of the card on the platen. The card will be imaged once again (step 500) and the software will scan the downloaded image for the presence of a 2D bar code (step 510). If a barcode is found, the processing subsystem 404 and authentication subsystem 406 will decode it and compare it to an extensive database 452 to authenticate the content and format of the bar code. If the DL card is known to have a magnetic stripe, either instead of or in addition to a barcode, the operator will be instructed to swipe the card through the magnetic stripe reader 422 and a similar authentication will be performed on the magnetic stripe data (step 510).

After all of the data from the front and back of the card has been collected, the processing subsystem 404 and authentication subsystem 406 determine whether or not the DL card should contain a digital watermark, based on an issuance date derived from the card data (step 515). With all of these pieces in place, the processing subsystem 404 and authentication subsystem 406 are is ready to complete the analysis of card authentication by comparing the results of all of the aforementioned tests (steps 530 through 535). Each set of results, including the physical characteristics, the machine-readable characteristics and the presence (or absence) of a DWM, will be assigned a weight and a final determination of card authentication will be made (steps 530 through 535). The DMV display 20 displays the results to the DMV employee 435. For example, in one embodiment, the results are displayed as either a green, yellow or red light, based on the scoring criteria. In the event of a yellow or red light, the operator will have the opportunity to query as to exactly what conditions contributed to the result (steps 555, 560). Depending upon the policies and business rules that a given issuer has in place, the operator will be given the chance to override the results or simply flag the results as being unsatisfactory (step 560). In any event, the images and data used to arrive at the results can be stored (step 575), allowing a forensic investigator to re-perform the analysis at a later time, without having physical possession of the actual DL card.

Passport Authentication The next example embodiment case involves the authentication of a passport offered as proof of identification during the application process. Passport authentication is similar to the above described process for driver's licenses. Passports however (at least at the present time) do not contain 2D bar code information. Thus, in this example, the images used for authentication can be captured in a single step. As described above, the process starts with the operator placing the photo page of the passport on an appropriate part of the document imaging subsystem 402, such as the platen of a reader (e.g., the AssurTec reader) or a scanner. The document imaging subsystem 402 automatically senses the presence of the document and images the photo page (again, under various conditions and wavelengths of light). The images are transmitted to the processing subsystem 404 and the analysis of the document will begin. Analysis will begin, as above with overall document recognition and extraction of text from the document's MRZ. These steps will identify the specific type of passport and the detailed analysis will include, as above, the detection and isolation of physical and security features of the document. The document may also be scanned for OCR extraction of plain text on the document face. In addition to performing an examination of the MRZ checksum validity, the last step of the analysis will include a scan of the document to check for the presence of a DWM.

Having collected all of the data, the final analysis will be conducted to determine the authenticity of the document as described in the DL authentication segment above. As before, the results of the analysis will be shown to the operator for final judgment. In some cases, the operator may be prompted to read an additional page of the passport to detect addition security features that may be contained on another page.

Notes

It should be understood that the above example (especially the decision logic, weighting, and scoring) is provided by way of example only and is not intended to be limiting. Those of skill in the art will appreciate that many different types of rules can be implemented, and the rules can be tailored to fit the particular information printed on the identification documents. In addition, although reference has been made throughout this document to a “DMV” and to specific identification documents such as driver's licenses, the invention is not so limited.

In addition, although many examples and aspects of the invention have been discussed in connection with the step of applicant verification (e.g., step 112 of FIG. 2), it should be understood that these examples and aspects of the invention are equally applicable to the card holder and ID authentication step 122 of FIG. 2.

### Additional ways to Implement Embodiments of the Invention

With additional (optional) integration, an embodiment of the invention can become the centerpiece of an advanced “front office” issuer solution. Within such a solution, the document authentication process remains essentially unchanged; however, the results of the authentication process become an essential part of the applicant intake process. An example of this is shown in FIG. 6, which is a high level block diagram of a system architecture for an identification document capture, issuance, and authentication system, in accordance with one embodiment of the invention. Integrated in this way, the results of any “yellow” or “red” light authentication result could automatically be forwarded to an onsite (or remote) supervisor who could review the detailed results of the authentication process and make further adjudication of the document without the need to rescan the original document. A “green” light authentication or supervisory override would be necessary for the applicant to proceed in the application process. In any event, selected (or, if desired, all) images captured can be archived to become part of a permanent record of the applicant's transaction. As an added benefit, appropriate information such as applicant name, birth date, etc., can be transferred after review to the intake application to pre-populate DL/ID fields, eliminating the need for the operator to manually enter this data.

To secure the document images captured for the archive, the system may apply one or more transformations to the document image data. These transformations of the image that enable protection against fraudulent use. Some transformations secure the image of the document from tampering while others enable tracking of the use of the document image to deter fraud. One transformation includes embedding a fragile digital watermark that enables integrity of the image of the first document to be verified. One form of fragile digital watermark imperceptibly modifies the data to enable tampering of the image to be detected and localized to particular image regions. Another form embeds a hash of image characteristics that is later used to verify that the image characteristics have not been altered. Another form of fragile watermark enables verification only if the digital watermark is readable from the image. If the image is tampered, the fragile watermark is un-recoverable and the image is deemed to be modified.

Another transformation includes linking the image to information about the time or place of scanning the image or the operator responsible for handling the image. For example, a digital watermark is embedded in the image that carries this information or carries an index to a database that records this information. In this case, a robust watermark can be used that survives subsequent manipulations, such as printing of the image to create a fraudulent breeder document or credential.

Another transformation includes linking the first image to a system that tracks transactions involving the first image. For example, the images may be archived in encrypted form, and all transactions involving handling of the images are tracked by the database that manages the encrypted images. A digital watermark embedded in the image may be used to link it to the database, and in particular, to a transaction log providing information about who accessed the image, the reason for the access, and the time and place. If the image is found to be used in an unauthorized manner, the embedded watermark provides a link to information that can be used by law enforcement to determine who leaked the image, and where and when the image was leaked.

Another transformation includes using an encryption protocol to secure the document image data. For example, the document image is encrypted and digitally signed upon capture by the scanner, and transferred to a secure database where its integrity and source are verified. Once verified (preferably behind a firewall), the document image may be re-encrypted in another format if desired, and managed according to the secure database scheme outlined in the previous paragraph. The digital signature may be used to verify that the data has not been altered. A digital signature may also be used to verify that the data has been obtained from a valid source. The system also preferably records metadata about the image (possibly in the header of the encrypted file), including information about the operator, time and location of capture, and any information about exceptional events such as operator overrides used at the time of document verification. For example, the operator may have allowed a name change override if the applicant's name has changed. In this case, data about this exception is entered and stored with the document image.

In another embodiment, the invention can be tied into systems such as watch lists, facial recognition databases, etc. For example, additional optional functionality of this embodiment of the invention includes the ability to send applicant data to a text watch list or to perform a facial recognition search on an available one-to-many facial recognition database (utilizing the photo captured during the authentication process—see previous description of the use of the biometric engine). Additionally, applicant demographic information captured during the authentication process can be used to query third-party data services (e.g., the identity verification engine 480 described previously). to allow receipt of additional information that can be used to further verify the identity of the applicant.

We believe that the embodiments of the invention described herein offer the most comprehensive document authentication available. In at least some embodiments, the architectural flexibility of the invention allows it to operate independently or as a tightly integrated piece of the licensing process.

In addition, the embodiments of the invention that include linked and layered security for identification documents described herein provides further advantages for issuers and users of identification documents. In particular, when the linked and layered secure identification documents are combined with the document verification system, we believe the resultant system is the most reliable means of verifying document authenticity and applicant identity presently known.

Concluding Remarks

In describing the embodiments of the invention illustrated in the figures, specific terminology (e.g., language, phrases, product brands names, etc.) is used for the sake of clarity. These names are provided by way of example only and are not limiting. The invention is not limited to the specific terminology so selected, and each specific term at least includes all grammatical, literal, scientific, technical, and functional equivalents, as well as anything else that operates in a similar manner to accomplish a similar purpose. Furthermore, in the illustrations, Figures, and text, specific names may be given to specific features, modules, tables, software modules, objects, data structures, servers, etc. Such terminology used herein, however, is for the purpose of description and not limitation.

Although the invention has been described and pictured in a preferred form with a certain degree of particularity, it is understood that the present disclosure of the preferred form, has been made only by way of example, and that numerous changes in the details of construction and combination and arrangement of parts may be made without departing from the spirit and scope of the invention. In the Figures of this application, in some instances, a plurality of system elements or method steps may be shown as illustrative of a particular system element, and a single system element or method step may be shown as illustrative of a plurality of a particular systems elements or method steps. It should be understood that showing a plurality of a particular element or step is not intended to imply that a system or method implemented in accordance with the invention must comprise more than one of that element or step, nor is it intended by illustrating a single element or step that the invention is limited to embodiments having only a single one of that respective elements or steps. In addition, the total number of elements or steps shown for a particular system element or method is not intended to be limiting; those skilled in the art can recognize that the number of a particular system element or method steps can, in some instances, be selected to accommodate the particular user needs.

Having described and illustrated the principles of the technology with reference to specific implementations, it will be recognized that the technology can be implemented in many other, different, forms, and in many different environments. The technology disclosed herein can be used in combination with other technologies. Also, instead of ID documents, the inventive techniques can be employed with product tags, product packaging, labels, business cards, bags, charts, smart cards, maps, labels, etc., etc. The term ID document is broadly defined herein to include these tags, maps, labels, packaging, cards, etc.

It should be appreciated that the methods described above as well as the methods for implementing and embedding digital watermarks, can be carried out on a general-purpose computer. These methods can, of course, be implemented using software, hardware, or a combination of hardware and software. Systems and methods in accordance with the invention can be implemented using any type of general purpose computer system, such as a personal computer (PC), laptop computer, server, workstation, personal digital assistant (PDA), mobile communications device, interconnected group of general purpose computers, and the like, running any one of a variety of operating systems. We note that some image-handling software, such as Adobe's PrintShop, as well as image-adaptive software such as LEADTOOLS (which provide a library of image-processing functions and which is available from LEAD Technologies, Inc., of Charlotte, North Carolina) can be used to facilitate these methods, including steps such as providing enhanced contrast, converting from a color image to a monochromatic image, thickening of an edge, dithering, registration, manually adjusting a shadow, etc. Computer executable software embodying the steps, or a subset of the steps, can be stored on a computer readable media, such as a diskette, removable media, DVD, CD, hard drive, electronic memory circuit, etc.).

Moreover, those of ordinary skill in the art will appreciate that the embodiments of the invention described herein can be modified to accommodate and/or comply with changes and improvements in the applicable technology and standards referred to herein. Variations, modifications, and other implementations of what is described herein can occur to those of ordinary skill in the art without departing from the spirit and the scope of the invention as claimed.

The particular combinations of elements and features in the above-detailed embodiments are exemplary only; the interchanging and substitution of these teachings with other teachings in this and the referenced patents/applications are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto.

Having described the preferred embodiments of the invention, it will now become apparent to one of ordinary skill in the art that other embodiments incorporating their concepts may be used. These embodiments should not be limited to the disclosed embodiments, but rather should be limited only by the spirit and scope of the description and figures.

1. A method for issuing an identification document comprising:
scanning an image of at least a first document provided by an applicant to verify identity of the applicant;
automatically reading machine readable information from the first document, the machine readable information comprises applicant data that is automatically sent to a plurality of databases for verification;
creating a data record associated with the applicant, the data record including an image of the first document; and
issuing the identification document, the identification document including embedded machine readable information linking the document to the data record.

2. (canceled)

3. The method of claim 1 wherein the data record includes information about an operator involved in issuing the identification document.

4. The method of claim 1 wherein the data record includes information about an issuer location involved in issuing the identification document.

5. The method of claim 1 wherein the embedded machine readable information comprises a digital watermark.

6. The method of claim 1 wherein the data record includes the machine readable information from the first document.

7. The method of claim 1 wherein the machine readable information from the first document is authenticated using a digital watermark.

8. (canceled)

9. The method of claim 1 wherein a secure router is used to send the applicant data to the plurality of databases.

10. The method of claim 1 wherein the applicant data comprises biometric information of the applicant.

11. The method of claim 1 wherein the machine readable information is used to pre-populate a form used to create the identification document.

12. The method of claim 1 wherein the data record is linked to information about an operator involved in issuing the identification document.

13. The method of claim 1 wherein the data record is linked to information about an issuer location involved in issuing the identification document.

14. A method for issuing an identification document comprising:
scanning an image of at least a first document provided by an applicant to verify identity of the applicant;
creating a data record associated with the applicant, the data record including an image of the first document;
automatically reading machine readable information from the first document to verify the applicant;
using at least part of the machine readable information from the first document to pre-populate a form used to create the identification document; and
generating the identification document based in part on the machine readable information.

15. The method of claim 14 including:
embedding at least a portion of the machine readable information in the document in addition to printing at least a portion of the machine readable information on the document.

16. The method of claim 15 including linking a first machine readable information carrier on the document with a second machine readable information carrier on the document, the linking enabling verification of the identification document.

17. The method of claim 16 wherein the first or second machine readable information carrier comprises a digital watermark.

18. The method of claim 17 wherein the digital watermark is embedded in biometric information on the identification document.

19-22. (canceled)

23. A method for issuing a credential comprising:
scanning an image of at least a first document provided by an applicant to verify identity of the applicant;
creating a data record associated with the applicant, the data record including an image of the first document;
applying a transformation to the image of the first document, the transformation enabling protection against fraudulent use of the image of the first document; and
generating the credential.

24. The method of claim 23 wherein the transformation includes embedding a fragile digital watermark that enables integrity of the image of the first document to be verified.

25. The method of claim 23 wherein the transformation includes linking the first image to information about the time or place of scanning the image.

26. The method of claim 23 wherein the transformation includes linking the first image to information about the operator responsible for scanning of the image.

27. The method of claim 23 wherein the transformation includes linking the first image to a system that tracks transactions involving the first image.

28. A method of verifying a credential comprising two or more layers, the method comprising:
automatically reading a machine readable logical attribute on a first layer of the credential, the first layer being unprotected by a physical security feature over at least part of the machine readable logical attribute;
automatically reading covert data embedded in a second layer of the credential, the second layer being protected by a physical security feature over at least part of an area in which the covert data is embedded in the second layer; and
comparing information from the covert data and the machine readable logical attribute to verify authenticity of the credential.

29. The method of claim 28 wherein the covert data comprises data from a digital watermark embedded in an image on the second layer.

30. The method of claim 28 wherein the covert data and the logical attribute are linked to a biometric of a bearer of the credential.

31. An identification document comprising:
a first document layer including a machine readable logical attribute, the first document layer being unprotected by a physical security feature over at least part of the machine readable logical attribute; and
a second layer of the credential including machine readable, embedded covert data, the second layer being protected by a physical security feature over at least part of an area in which the covert data is embedded in the second layer; wherein information from the covert data and the machine readable logical attribute are related to enable verification of the identification document.
